(19) United States
(12) Patent Application Publication
(10) Pub. No.: US 2006/0277140 A1
(43) Pub. Date: Dec. 7, 2006

(54) Automated foreclosure and asset disposition methods, systems, and computer program products

(75) Inventors: William Sutton Cherry JR., Raleigh, NC (US); Dale Joel Lee, Fuquay Varina, NC (US); Ellen Margaret Kinsinger, Raleigh, NC (US)

Correspondence Address: JENKINS, WILSON, TAYLOR & HUNT, P. A., 3100 TOWER BLVD, SUITE 1200, DURHAM, NC, 27707, US

(73) Assignee: Poyner & Spruill, LLP, Raleigh, NC (US)

(21) Appl. No.: 11/375,707

(22) Filed: Mar. 14, 2006

Related U.S. Application Data
(60) Provisional application No. 60/661,681, filed on Mar. 14, 2005.

(51) Int. Cl. G06Q 40/00

(52) U.S. Cl. 705/38

(57) ABSTRACT

Automated foreclosure and asset disposition methods, systems, and computer program products are provided, such as for automating a property foreclosure matter. According to one aspect, the subject matter described can include providing a data inquiry for receiving user input relating to a foreclosure matter. In response to the data inquiry, information can be retrieved over a data network relating to the foreclosure matter and documents can be generated relating to the foreclosure matter either automatically or in response to a document request. Information can be presented such as, for example, tracking information relating to the foreclosure matter.

### CROSS-REFERENCE TO RELATED APPLICATION

This application claims the benefit of U.S. Provisional Patent Application Ser. No. 60/661,681 entitled “AUTOMATED FORECLOSURE SYSTEM AND METHOD”, and filed Mar. 14, 2005; the disclosure of which is incorporated by reference herein in its entirety.

### TECHNICAL FIELD

The subject matter disclosed herein relates to foreclosure proceedings. More particularly, the disclosed subject matter relates to methods, systems, and computer program products for automating a foreclosure proceeding and asset distribution, such as, for example, automating the various processes and document generation requirements for a property foreclosure proceeding.

### BACKGROUND

The financing of real property, such as residential buildings, typically involves various types and kinds of residential mortgage plans. With a typical mortgage, a lender loans money to a borrower who is purchasing residential property, and the loan is collateralized pursuant to a mortgage plan that usually includes a mortgage lien on the legal title to the property. The legal terms and conditions of the mortgage plan can vary from time to time, but they typically involve payment provisions requiring the borrower to pay back the loan in equal monthly installments wherein each installment includes a principal payment portion and an interest payment portion. The monthly payments are made by the borrower over the length of the mortgage term, until the payments are made in full or the mortgage is prematurely paid off.

A small percentage of all homes sold today will eventually go to foreclosure. A foreclosure occurs when the lender of money to purchase real property is not paid back in a timely manner. There are several types of conditions that can lead to foreclosures, such as divorce, job loss, etc., and there are several types of foreclosures. When a homeowner experiences financial hardship and is not adequately prepared, a foreclosure is most likely to be the end result. Typically, once a homeowner is several months behind, the mortgage holder (lender) will not be able to negotiate with the homeowner as special exemptions cannot be made for every homeowner going through difficult times. Therefore, a foreclosure proceeding will be commenced so that the property can be disposed of at a price optimally at least enough so that the lender can receive the sum of money owed to it plus expenses.

In the past, the impacts from conducting a foreclosure process have been extremely burdensome for all parties. The process is protracted by regulation and disjointed because the participating agents, workers, institutions, and individuals are linked throughout the transaction by means such as face-to-face meetings, telephone conversations, fax, postal mail, private and public delivery contractors (e.g., Sheriff's Department), e-mail, and electronic file transmittal. While in some instances these means are considered by some to be state-of-the-art, the human element remains inherent in all of these mechanisms. It is typical that time is consumed from the beginning and throughout the foreclosure process because a person is involved at virtually every step of the process. Typically, individuals involved in a foreclosure matter process information serially, that is, attending to one requirement after another, rather than by attending to pertinent information and service requests in parallel where multiple tasks can be handled or processed simultaneously. In the end, however, a foreclosure process can be complicated, time consuming and error prone due to the need for most aspects to be completed manually.

Therefore, there remains a long felt need to provide at least some form of automation to a foreclosure proceeding and to asset distribution, such as by providing automated foreclosure methods, systems, and computer program products, such as for a property foreclosure.

### SUMMARY

In accordance with the subject matter disclosed herein, novel automated foreclosure and asset disposition methods, systems, and computer program products are provided.

Accordingly, it is an object of the subject matter disclosed herein to provide automated foreclosure and asset disposition methods, systems, and computer program products. An object of the present subject matter having been stated and which is achieved, in whole or in part, by the presently disclosed subject matter, other objects may become apparent as the description proceeds when taken in connection with the accompanying drawings as best described hereinbelow.

### BRIEF DESCRIPTION OF THE DRAWINGS

Exemplary embodiments of the subject matter will now be explained with reference to the accompanying drawings, of which:

FIG. 1 is a flow chart illustrating exemplary steps of the automated foreclosure system and method according to an aspect of the subject matter disclosed herein;

FIG. 2 is a flow chart illustrating exemplary steps of a process associated with matter intake according to an aspect of the subject matter disclosed herein;

FIG. 3 is a flow chart illustrating exemplary steps of a process associated with appointment of a substitute trustee according to an aspect of the subject matter disclosed herein;

FIG. 4 is a flow chart illustrating exemplary steps of a process associated with scheduling a hearing according to an aspect of the subject matter disclosed herein;

FIG. 5 is a flow chart illustrating exemplary steps of a process associated with a notice of hearing according to an aspect of the subject matter disclosed herein;

FIG. 6A is a flow chart illustrating exemplary steps of a process associated with a hearing according to an aspect of the subject matter disclosed herein;

FIG. 6B is a flow chart illustrating exemplary steps of a process associated with a continuance or amended hearing notice according to an aspect of the subject matter disclosed herein;

FIG. 6C is a flow chart illustrating exemplary steps of a process associated with a motion to continue (parties not served) according to an aspect of the subject matter disclosed herein;

FIG. 7 is a flow chart illustrating exemplary steps of a process associated with a notice of sale according to an aspect of the subject matter disclosed herein;

FIG. 8A is a flow chart illustrating exemplary steps of a process associated with a sale according to an aspect of the subject matter disclosed herein;

FIG. 8B is a flow chart illustrating exemplary steps of a process associated with postponement or amendment of a sale according to an aspect of the subject matter disclosed herein;

FIG. 8C is a flow chart illustrating exemplary steps of a process associated with an upset bid according to an aspect of the subject matter disclosed herein;

FIG. 8D is a flow chart illustrating exemplary steps of a process associated with an assigned bid according to an aspect of the subject matter disclosed herein;

FIG. 8E is a flow chart illustrating exemplary steps of a process associated with a trustee affidavit according to an aspect of the subject matter disclosed herein;

FIG. 9A is a flow chart illustrating exemplary steps of a process associated with a final sale (lender purchaser) according to an aspect of the subject matter disclosed herein;

FIG. 9B is a flow chart illustrating exemplary steps of a process associated with a note of foreclosure according to an aspect of the subject matter disclosed herein;

FIG. 9C is a flow chart illustrating exemplary steps of a process associated with a final sale (third party purchaser) according to an aspect of the subject matter disclosed herein;

FIG. 9D is a flow chart illustrating exemplary steps of a process associated with a non-responsive purchaser according to an aspect of the subject matter disclosed herein;

FIG. 9E is a flow chart illustrating exemplary steps of a process associated with a defaulted deposit and resale according to an aspect of the subject matter disclosed herein;

FIG. 10 is a flow chart illustrating exemplary steps of a process associated with disbursement of funds according to an aspect of the subject matter disclosed herein;

FIG. 11A is a flow chart illustrating exemplary steps of a process associated with asset disposition according to an aspect of the subject matter disclosed herein;

FIG. 11B is a flow chart illustrating exemplary steps of a process associated with an asset disposition sale according to an aspect of the subject matter disclosed herein;

FIG. 12A is a flow chart illustrating exemplary steps of a process associated with a dismissal of foreclosure contingency according to an aspect of the subject matter disclosed herein;

FIG. 12B is a flow chart illustrating exemplary steps of a process associated with a bankruptcy contingency according to an aspect of the subject matter disclosed herein;

FIG. 12C is a flow chart illustrating exemplary steps of a process associated with a foreclosure error contingency according to an aspect of the subject matter disclosed herein;

FIGS. 13A-13U are illustrations of computer screen pages that can be presented during various processes associated with an aspect of the subject matter disclosed herein;

FIGS. 14A-14B are illustrations of computer screen pages related to a workflow summary that can be presented during various processes associated with an aspect of the subject matter disclosed herein; and

FIG. 15 is a block diagram of network components which can encompass the system and method according to an aspect of the subject matter disclosed herein.

### DETAILED DESCRIPTION

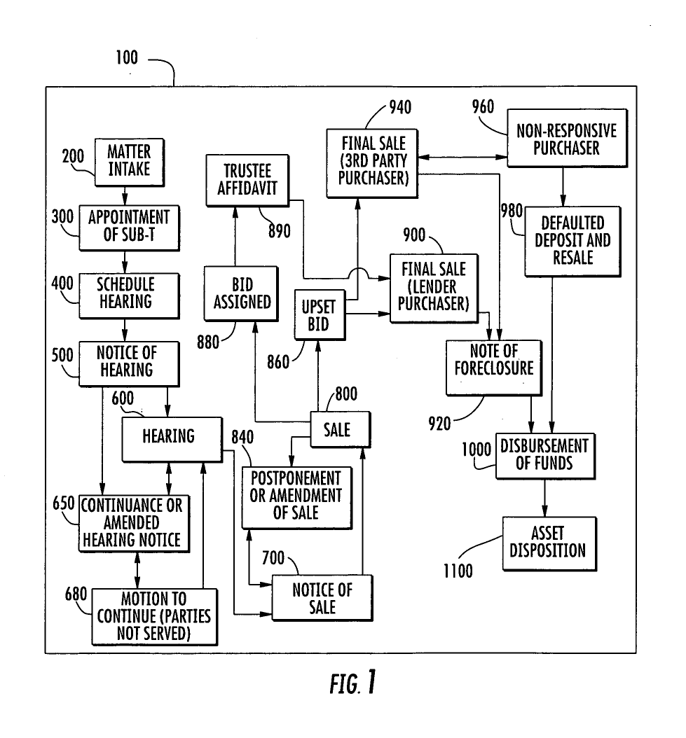

In an exemplary embodiment and without limitation, the methods, systems and computer program products of the present subject matter relate to an automated foreclosure process 100 as shown for illustration purposes in FIG. 1. Foreclosure process 100 can be divided typically into two separate time periods, each made up of individual processes that will be described in further detail below. The first time period can involve the actual foreclosure process and can consist of matter intake 200, appointment of substitute trustee (Sub-T) 300, scheduling of hearing 400, notice of hearing 500, and hearing 600 or continuance/amend hearing notice 650, or motion to continue (parties not served) 680. The second time period can involve the foreclosure sale and can consist of notice of foreclosure sale 700, sale 800 or postponement/amendment of sale 840, upset bid 860, assignment of bid 880 and trustee affidavit 890, final sale to lender purchaser 900 or final sale to third party purchaser 940, non-responsive purchaser 960 and defaulted deposit and resale 980, disbursement of funds 1000, and asset disposition 1100.

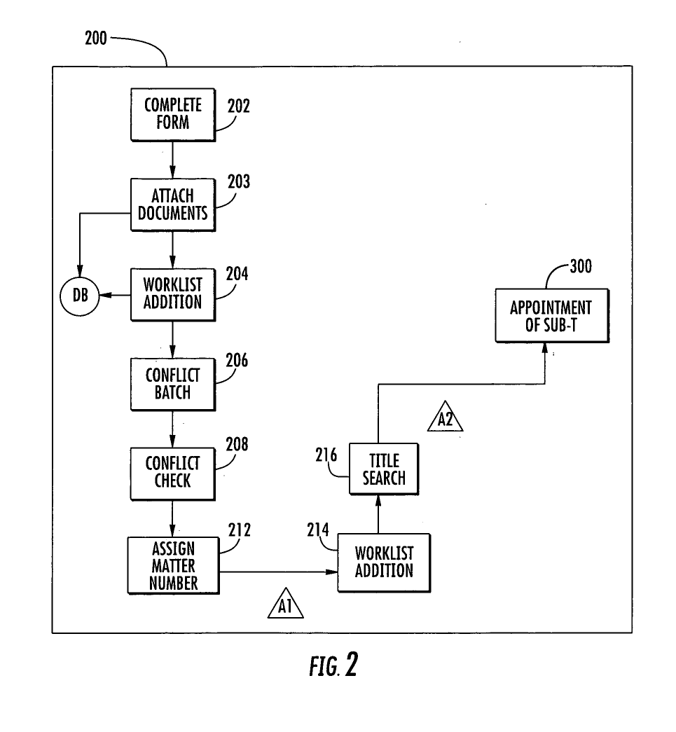

Referring to FIG. 2 of the drawings, the first step in the foreclosure process can be a matter intake 200. In order to begin this process, an intake form completion step 202 can be conducted wherein a loan officer with the current mortgage holder (e.g., lender) can electronically complete an intake form. This intake form can be computer based, such as a network-based or web-based form, and it can contain all information related to the mortgage and the real property associated with the mortgage required to set up the matter and begin the foreclosure process. Such information can include for example: the county where the property is located; number of parties to the action; party type (e.g., business or individual); party name, address and relationship type; name of original trustee; name and address of original note holder; property address and legal description; property type (e.g., residence, apartments, commercial, unapproved reality, mobile home, etc.); year, make, model, VIN and title number if property is a mobile home; month, date, and year of original deed of trust; month, date and year of original promissory note; book, page, date of recordation of original deed of trust and any other recordation information as applicable; loan numbers(s); and original principal amount of the mortgage note. As intake form step 202 is been completed, documents can be uploaded by a lender loan officer as in step 203. In this step, any applicable attachments such as the promissory note, deed of trust, loan history, demographic information on borrowers, credit bureau report, guarantee, guarantee agreements, title insurance, tile opinion, and modification agreement can be reviewed, printed, and/or downloaded. Throughout foreclosure process 100, relevant information can be electronically uploaded (stored) and/or downloaded from a central database DB. This information can include, for example, electronic scans of various documents and items for e-filing with an electronic record system (if available and applicable).

Referring further to FIG. 2, once intake form step 202 and document attachment step 203 are completed, the information can be submitted and transmitted electronically to a representative paralegal that can oversee the foreclosure process. In step 204, the matter information can be submitted electronically and appear on a paralegal's electronic worklist for review and approval. Such a worklist can be present on the paralegal's computer, and the paralegal can be automatically alerted by means of visual indicators, email alerts, or the like. Once the matter appears on the paralegal's worklist in step 204, the paralegal can open the new matter for review. In this case, a split screen on the paralegal's graphical interface can be initiated wherein client intake specific fields entered by the lender loan officer can be visible on the left side of the screen and related scanned documents from the lender are visible on the right side of the screen. Once the paralegal has approved the intake form, the matter can then be automatically added to the accounting system where a conflict check batch file is created in step 206 wherein the matter (such as parties, etc.) can be electronically compared to a database, such as a client database, to determine the potential of any conflicts. Additionally, a matter number is generated as in step 212. Once these steps are performed, the paralegal can be automatically notified that the Remand Letter and Appointment of Substitute Trustee must be generated (see step 302 below).

Referring additionally to FIG. 2, the system can comprise numerous alarms, such as visual or email indicators, which can automatically alert a user when certain actions are required or overdue. For instance, alarm A1 can be automatically activated when a new client matter has not been assigned a matter number within a certain number of days (e.g., two days after intake, etc.). In step 214, the matter can be placed automatically on the assigned local agent's (if applicable) worklist for initiation of a title search on the subject property. In step 216 a title search can be conducted and the results can be entered by the local agent or title analyst and electronically uploaded to database DB. A title search must be completed before a “Notice of Hearing” is issued (discussed hereinbelow). Additionally, an alarm A2 can be provided to automatically alert the paralegal, title analyst, and attorney when a title search has not been completed within a certain amount of time (e.g., ten days) after assignment to the local agent or title analyst. If the title search uncovered additional parties to the action, they can be added to the database. Additionally, if any special proceeding is identified against one or more of the parties to the action, a special alert can be provided to the lender. Once this step is submitted, it can be approved by the attorney so the substitute trustee can be appointed as described below.

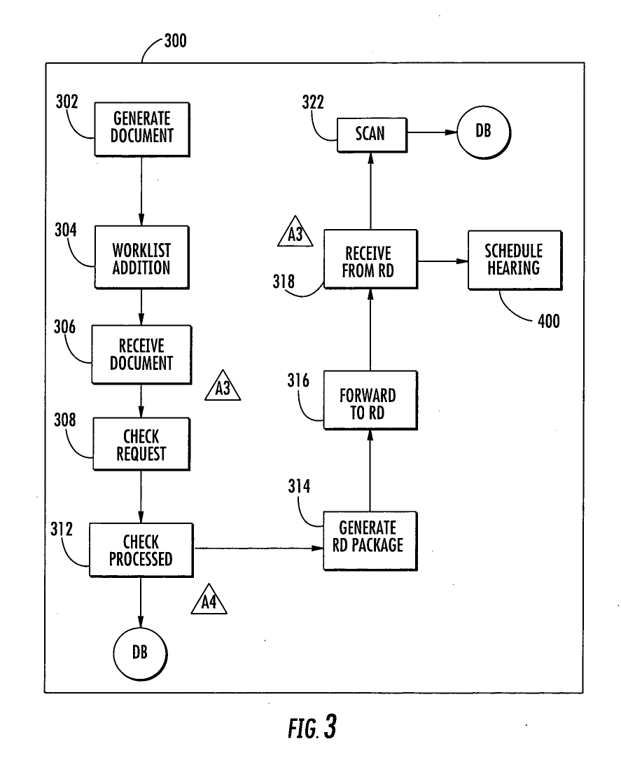

Referring to FIG. 3 in reference to process 300, once the substitute trustee is assigned by the attorney, the substitute trustee documents can be generated by the paralegal, and these documents can be recorded with the Register of Deeds (RD). In step 302, an “Appointment of Substitute Trustee” document can be generated. In step 304, an indication to generate, print, sign and return the “Appointment of Substitute Trustee” document can be placed on the lender's worklist, and when this document has been opened and printed by the lender, the paralegal can be automatically notified. The paralegal can receive an executed copy of the “Appointment of Substitute Trustee” document (typically through postal mail) from the lender in step 306, and if the reference document is not generated and signed by the lender within a certain amount of time (e.g., seven days), an alarm A3 can be automatically activated to notify the paralegal. Once the executed “Appointment of Substitute Trustee” document is received from the lender, a check request 308 can be made by the system, such as to an accounting department, for a check to be issued for recordation of the document. In step 312, the accounting department can automatically receive the check request and can process the request for issuance of a check to the paralegal. Before routing of the check is completed, the check can be scanned and e-filed (e.g. uploaded) into database DB for filing with an electronic record of the matter, if such a system is applicable. An alarm A4 can be provided that can automatically alert the paralegal if the check has not been received from the accounting department within a certain amount of time (e.g., one day).

Referring further to FIG. 3, recordation documents, such as a cover letter, envelope, return envelope, etc., can be generated by the system in order to forward all applicable documents to the Register of Deeds (RD) for recordation as in step 314. In step 316, the original signed “Appointment of Substitute Trustee” document and two copies, with cover letter, check, envelope, and return envelope can be prepared and mailed to the Register of Deeds for recordation. In step 318, the recorded original “Appointment of Substitute Trustee” can be returned from the Register of Deeds with the applicable date, book, and page number of recordation. An alarm A5 can be provided if the recorded “Appointment of Substitute Trustee” is not received back from the Register of Deeds in a certain amount of time (e.g., three days). If the recorded document has not been received, the paralegal can contact the Register of Deeds in order to obtain the recordation information for entry into the system. If applicable for electronic filing purpose, the recorded “Appointment of Substitute Trustee” documents can be scanned as in step 322 and e-filed in database DB for file maintenance purposes. At this point, the process moves to process 400 wherein the foreclosure hearing is scheduled.

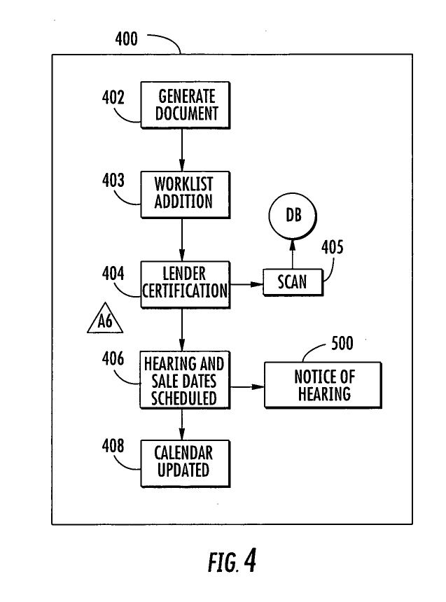

Turning now to FIG. 4, the next process to be completed can be the scheduling of the foreclosure hearing 400. In step 402, a “30 Day Statement Letter” can be generated by the system and can be placed on the lender's worklist for action as in step 403. Upon notification, the lender officer can enter the required fields and premium amounts in the “30 Day Statement Letter” and the letter can be printed on lender stationary with the requisite envelope and mailed. In step 404, a lender officer can electronically certify that the letter has been mailed, and a copy of the signed letter can be scanned as in step 405 and uploaded to database DB. If the “30 Day Statement Letter” is not printed, sent and uploaded within a certain amount of time, an alarm A6 can be provided to automatically notify the paralegal. Upon confirmation of sending of the “30 Day Statement Letter”, the paralegal can schedule the hearing date and sale date with the Clerk of Courts (C of C) as in step 406. Once scheduled and entered into the system, the hearing date and sale date can be automatically sent to a calendar, such as a matter calendar or an attorney/paralegal in-box calendar, as shown in step 408. The matter can then proceed to process 500 for the notice of hearing.

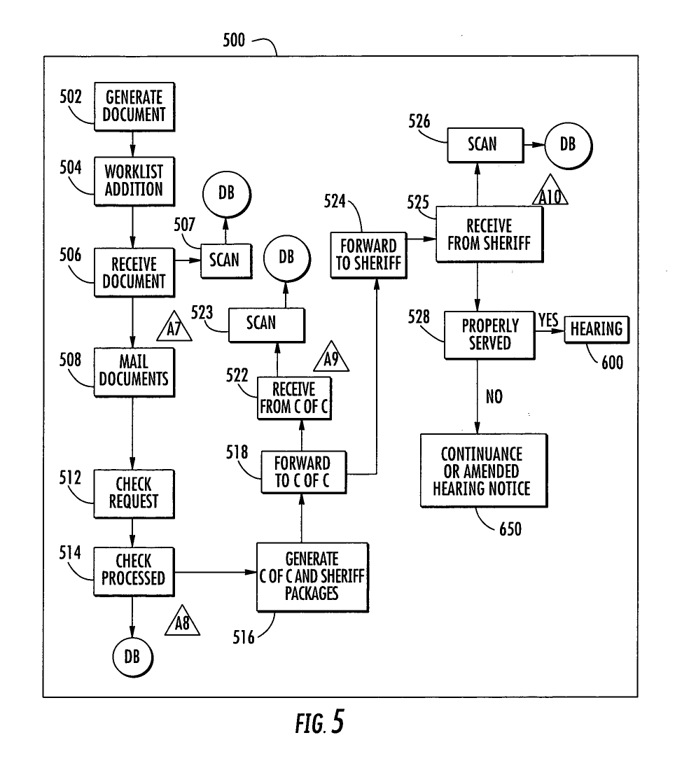

Referring to FIG. 5, the process of the notice of hearing 500 can begin with the generation of a “Notice of Hearing” document (and Special Proceedings Action Cover Sheet, or SPACS) by the system in step 502. In step 504, an indication can be placed on the substitute trustee's worklist for printing, signing and returning of the “Notice of Hearing” and SPACS. In step 506, the signed “Notice of Hearing” and SPACS can be received from the substitute trustee and can be electronically scanned as in step 507 and e-filed in database DB, if applicable. An alarm A7 can be provided to automatically notify the paralegal if the signed “Notice of Hearing” is not received back from the substitute trustee within a certain amount of time (e.g., five days). In step 512 a check request can be made for checks payable to the Clerk of Courts for recordation and for checks to the Sheriff's Department for personal service and property posting, etc., such as, for example, to an accounting department. In step 514, the applicable checks can be processed by the accounting department and can be scanned and e-filed to database DB as applicable. An alarm A8 can be provided to automatically provide notice to the paralegal should the checks not be received from the accounting department within a certain amount of time.

Referring further to FIG. 5, a Clerk of Courts package and a Sheriff's package can be generated by the system for proper recordation and serving of the documents as in step 516. The Clerk of Courts package can include, for example, a cover letter, a special proceedings action cover sheet, an original signed “Notice of Hearing” and three copies, a copy of the “30 Day Statement Letter”, a check payable to the Clerk of Courts, and a return envelope for return of the filed “Notice of Hearing”. The Sheriff's package for a Sheriff in the same county as the subject property can include, for example, a cover letter to the Sheriff, affidavit(s) of service, affidavit of posting for the subject property (with a map survey if available), return envelope(s) for returning of the affidavit(s) of service and posting, and a check payable to the Sheriff's Department for each person being served plus the property posting. If parties are being served in a county other than that where the property is located, the Sheriff's package can include, for example, a cover letter to the Sheriff, affidavit(s) of service for each person being served, return envelope(s) for each affidavit of service, and a check payable to the Sheriff's Department for each person being served. In step 518, the Clerk of Courts package and Sheriff package can be mailed to the Clerk of Courts, wherein the Clerk of Courts in turn can mail the Sheriff's package to any Sheriff out of the county where the property is located (see step 524). In step 522, the original filed “Notice of Hearing” can be returned from the Clerk of Courts, scanned as in step 523 and a copy of the document with the filing date is entered into database DB. An alarm A9 can be provided to automatically alert the paralegal if the filed “Notice of Hearing” has not been received from the Clerk of Courts within a certain amount of time. Upon receipt of the “Notice of Hearing” from the Clerk of Courts with the assigned case number, copies of the document can be mailed (e.g., via certified mail and/or regular mail) to all parties. In step 524, the Sheriff's package as discussed above is forwarded to the Sheriff. In step 525, a signed affidavit of service for each party served and a signed affidavit of posting for property can be received from the Sheriff and these documents can be scanned as in step 526 and e-filed in database DB, as applicable. An alarm A10 can be provided to automatically notify the paralegal if the signed affidavit of service for each party and affidavit of posting for the property are not received back from the Sheriff within a certain amount of time (e.g., thirty days).

Referring additionally to FIG. 5, once the service documents have been returned and entered in the system, step 528 determines whether the affidavits were properly served based on a tracking of who has been served, where they were served, the serve dates and whether the property affidavits were properly posted. For instance, parties must typically be served in some time period, for example at least ten days, before the hearing and may only be able to be served at a home address (i.e., cannot be served at a business unless the business is owned by the borrower). Additionally, the property post date must typically be some time period, for example, more than twenty days, from the hearing date. If the affidavits have been properly served and the property properly posted, then the matter can continue onto process 600 for conducting the hearing. If any of the parties have not been properly served or the property was not properly posted, then the matter can proceed to process 650 wherein a continuance or amended hearing notice can be prepared, as described further hereinbelow.

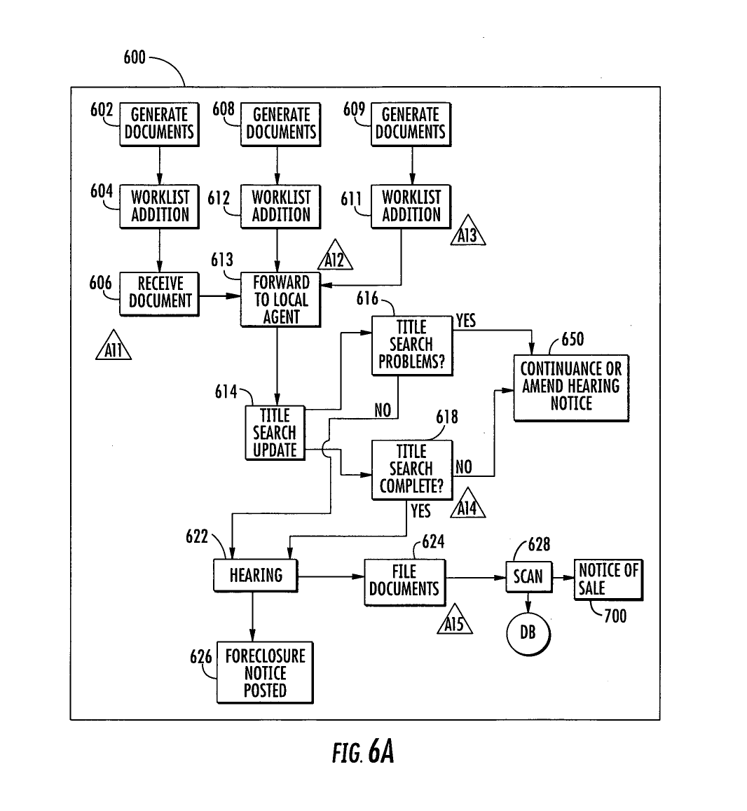

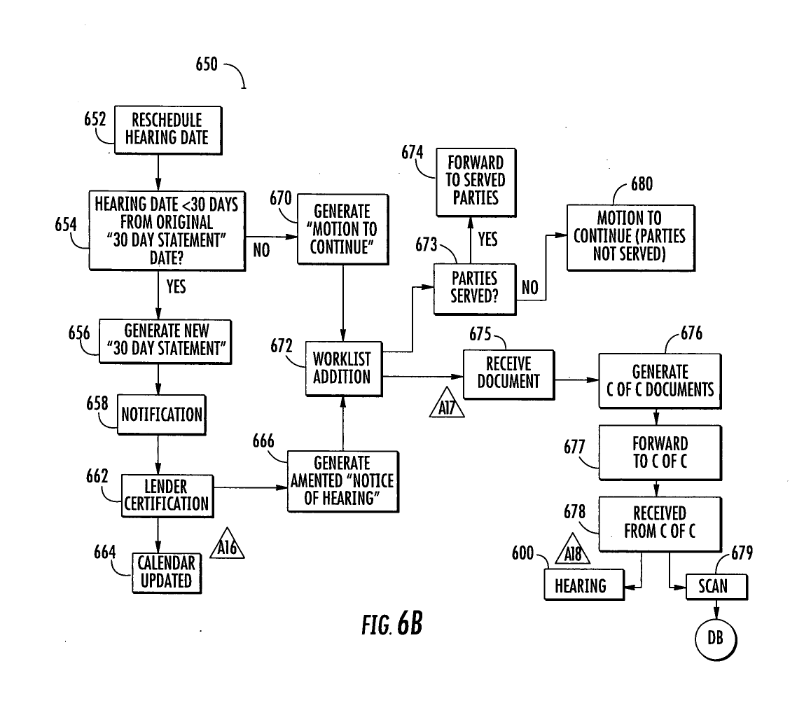

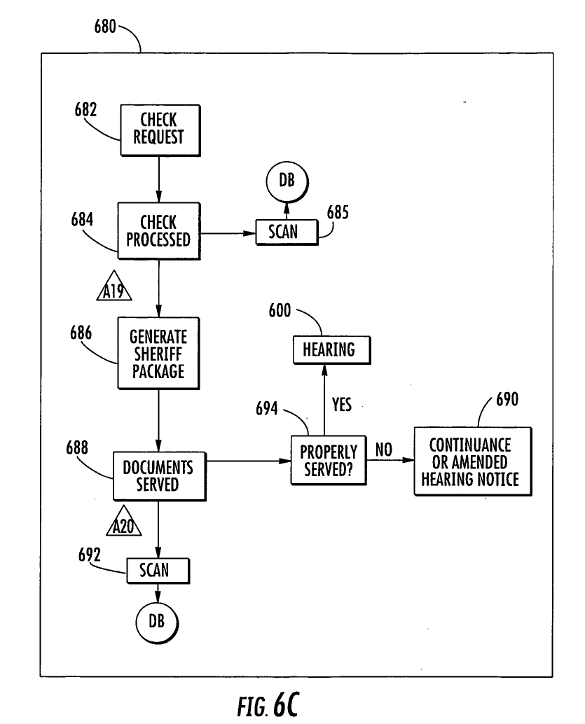

Referring to FIG. 6A, once a determination is made in step 528 above that the parties were properly served and the property was properly posted, the hearing process 600 can be conducted. First, in step 602, a “Beneficiaries Affidavit” can be generated by the lender. In step 604, the “Beneficiaries Affidavit” can be placed on the lender officer's worklist for input of required fields, printing, signing and mailing back to the substitute trustee. In step 606, the signed “Beneficiaries Affidavit” can be received from the lender, and an alarm A11 can be provided if the lender does not return the signed document within a certain amount of time (e.g. one week before the hearing date). In step 608, the generate “Trustee Affidavit Regarding Hearing” and “Notice of Foreclosure Sale” documents indicator is produced and can be added to the substitute trustee's worklist for generation, printing and signing as in step 612. An alarm A12 can be provided in order to automatically notify the paralegal if the “Trustee Affidavit” and “Notice of Foreclosure Sale” have not been printed by a certain day (e.g., the day before the hearing date). In step 609, the generate “Findings and Order” document indicator can be added to the substitute trustee's worklist for generation and printing as in step 611, wherein an alarm A13 can be provided if the “Findings and Orders” document is not printed by the substitute trustee within a certain amount of time. The substitute trustee can print the applicable documents and sign the “Trustee Affidavit” and the “Notice of Foreclosure Sale”, and all documents can be sent to the local agent (if applicable) as in step 613. At this point and in step 614, the local agent or title analyst can conduct an update to the original title search.

Referring further to FIG. 6A, in step 616 it can be indicated if the updated title search reveals that the property has been deeded out, the description changed, or any other interested parties are identified. If so, then the hearing can be continued, for example for at least thirty days, so that proper notice can be given, by following steps described below in reference to process 650. If it is not determined that the property has been deeded out or other interested parties are identified, then the process can proceed to step 622 as described below. Additionally, as shown in step 618, a query can be electronically performed to determine if the updated title search is completed before the hearing date (an alarm A14 can be provided if this updated title search has not been completed before a certain day (e.g., the day before the hearing), or if the lender requests postponement of the hearing. In either of these circumstances, a Motion to Continue can be made through process 650 described below. If the title search does not indicate a postponement or the bank has not requested postponement, then the process can proceed to step 622. In step 622, the foreclosure hearing can be provided in which the hearing attendee is in attendance with all relevant hearing documents. Upon conclusion of the hearing 622, the hearing attendee can file all documents with the Clerk of Courts as in step 624, and the hearing attendee can file the documents with the Clerk of Courts. In step 626, the “Notice of Foreclosure Sale” can be posted at the Clerk of Courts office, and in step 628 all filed documents related to the foreclosure to this point can be scanned and e-filed in database DB as applicable. An alarm A15 can be provided to automatically notify the paralegal if the filed documents are not uploaded from the hearing attendee within a certain amount time (e.g., three days after the hearing date). At this point, the matter continues with process 700 for the notice of foreclosure sale which is described further hereinbelow.

With reference to FIG. 6B and as described above, there are certain instances in which a process of a continuance or amended hearing notice 650 is needed. In step 652, the Clerk of Courts can be contacted in order to reschedule the hearing date. A query can be electronically conducted in step 654 to determine if the new hearing date is less than 30 days from the original “30 Day Statement Letter” date. If so, then the process can continue to step 656, but if not, the process can continue to step 670. In step 656, a new “30 Day Statement Letter” can be placed on the bank worklist for generation. When the “30 Day Statement Letter” has been generated by the bank, the paralegal can be notified as in step 658. Upon generating, the bank officer can enter the balance and premium amounts, the letter can be printed on bank stationary (for certification), with electronic signature and envelope, and the bank officer can mail the letter to the property owner as in step 662 with a copy uploaded to the database. An alarm A16 can be provided to automatically notify the paralegal if this document is received by the bank within a certain amount of time. Upon receipt of the “30 Day Statement Letter” from the bank, the new hearing date and sale date can be provided to matter and attorney/paralegal calendars in step 664. At this point, in step 666, an “Amended Notice of Hearing” can be generated by the system for forwarding to the substitute trustee. If the query in step 654 above indicates that step 670 is to be performed, new “Motion to Continue” documents can be generated by the system with a new sale date calculated typically thirty days from the new hearing date. These documents can be put on the substitute trustee's worklist to be generated.

Referring further to FIG. 6B, the “Motion to Continue” or the “Amended Notice of Hearing” can be placed on the substitute trustee's worklist for generation, printing and signing as in step 672. Upon signing of the applicable document, a query can be electronically run as in step 673 to determine if all parties have been previously served. If previously served, a copy of the signed document can be sent to all parties (typically via regular mail) as in step 674. If it is determined that there are parties that have not previously been served, process 680 for processing of a motion to continue to parties not served can be performed as described below. In step 675, the original signed documents can be received from the substitute trustee, and an alarm A17 can be provided to automatically notify the paralegal if the signed documents are not returned from the substitute trustee in a certain amount of time. Once the signed applicable forms are received from the substitute trustee, the system can generate the necessary cover letter and envelopes as in step 676, and the signed “Motion to Continue” or “Amended Notice of Hearing” documents can be sent to the Clerk of Courts office, along with two copies and a return envelope, as in step 677. In step 678, the filed document can be received from the Clerk of Courts office, and an alarm A18 can be provided if the filed documents are not returned from the Clerk of Courts within a certain amount of time (e.g., seven days). Upon receipt of the original filed documents, the filed copy of the “Motion to Continue” or “Amended Notice of Hearing” can be scanned as in step 679 and e-filed in database DB as applicable in step 678. The matter then moves forward to process 600 for conducting of the hearing as described hereinabove.

As described above in reference to step 674, wherein a copy of the signed document is mailed to all served parties, in the case that a party has been determined to have not been served, process 680 for a motion to continue to parties not served can be conducted, as shown in FIG. 6C. In this case, a check request in step 682 can be made to an accounting department for a check payable to the Sheriff Department for each person being served plus for the property posting. In step 684, this check request can be processed, the check can be scanned as in step 685 and e-filed in database DB as applicable, and the check can be forwarded to the requester. An alarm A19 can be provided to alert the paralegal if the check has not been received from the accounting department within a certain amount of time (e.g., one day). In step 684, an amended Sheriff's package can be generated by the system, which includes an amended “Affidavit of Service” and “Affidavit of Posting” with a cover letter to the Sheriff's department. These documents, along with the “Notice of Hearing” and the “Motion to Continue” or “Amended Notice of Hearing” can be forwarded to the Sheriff's department for serving of the documents on all applicable parties as in step 688. Once the affidavits are served and posted, they can be returned to the legal representative, wherein the signed affidavit of service for each party served and the signed affidavit of posting for the property can be electronically scanned as in step 692 and e-filed in database DB, as applicable. Alarm A20 can be provided to automatically alert the paralegal if the signed documents are not received from the Sheriff within a certain amount of time (e.g., ten business days before the hearing date). Once the signed documents are received from the Sheriff and reviewed, it is determined (similar to step 528) whether the parties were all properly served and that the property was properly posted. If all service and posting was proper, then the matter can continue to process 600 for the hearing, but if the parties were not properly served or the property was not properly posted, then the matter can continue with process 650, both processes as described hereinabove.

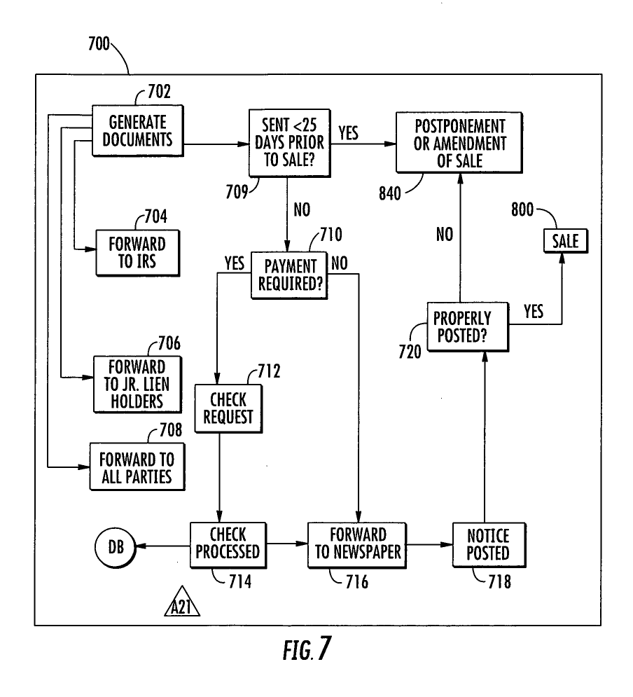

Referring now to FIG. 7, the notice of foreclosure sale as in process 700 will now be described. In step 702, the “Notice of Foreclosure Sale” or “Amendment or Postponement of Foreclosure Sale” documents can be sent with a cover letter to the IRS, if applicable, with a notice of the federal tax lien(s) (preferably by certified mail) as in step 704; a copy of the notice of foreclosure sale documents can be sent with a cover letter to any junior lien holders as in step 706; and a copy of the notice of foreclosure sale documents can be sent to all other parties as in step 708. In step 709, a query can be electronically performed to determine whether the notice was sent within a statutorily defined time period (e.g., twenty five days) prior to the date of sale. If query 709 determines that the notice was sent in less than the statutorily defined number of days, then the matter can move to process 840 as described further hereinbelow. Otherwise, the process can move to step 710.

Referring further to FIG. 7, step 710 determines whether the newspaper used to publish the notice requires pre-payment before publishing. If the newspaper does require pre-payment, a check request can be made as in step 712 to an accounting department. The accounting department can process the check, electronically scan and e-file it within database DB (if applicable), and forward the check as in step 714. An alarm A21 can be provided to automatically notify the paralegal if a check has not been received from the accounting department within a certain amount of time (e.g., one day). Upon receipt of the check in step 714, or if the newspaper does not require pre-payment (see step 710), step 716 can be performed wherein the system can generate a cover letter and affidavit for forwarding of the notice to the newspaper. In step 718, the “Notice of Foreclosure Sale” can be posted in the newspaper in order to provide proper notice. The matter can then move on to process 800 for sale of the property if the statutory time frame has been met or the matter can move to process 840 for postponement or amendment of the sale, if the time frame has not been met, both processes of which will be described below.

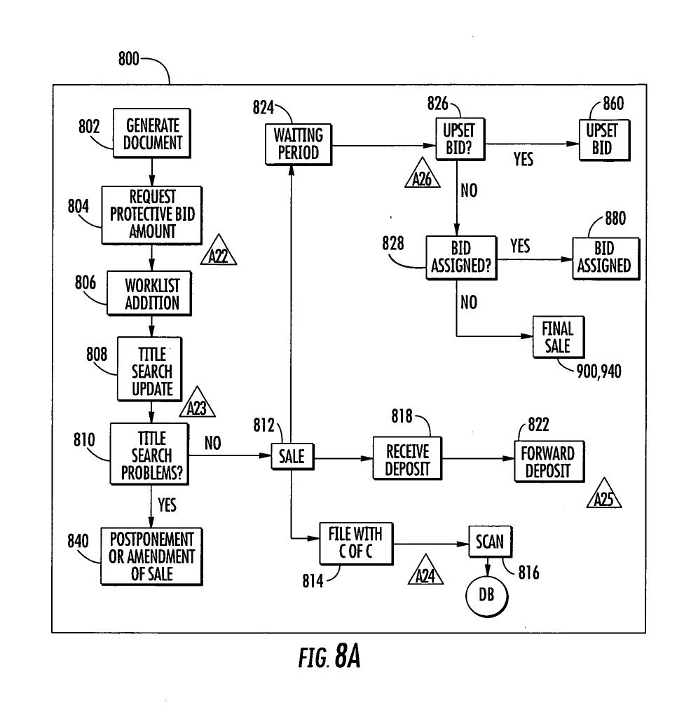

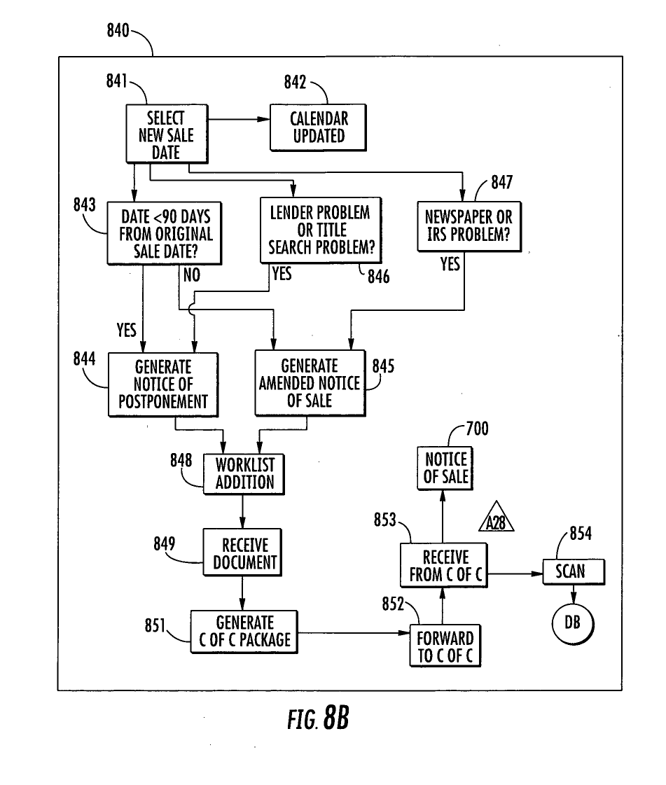

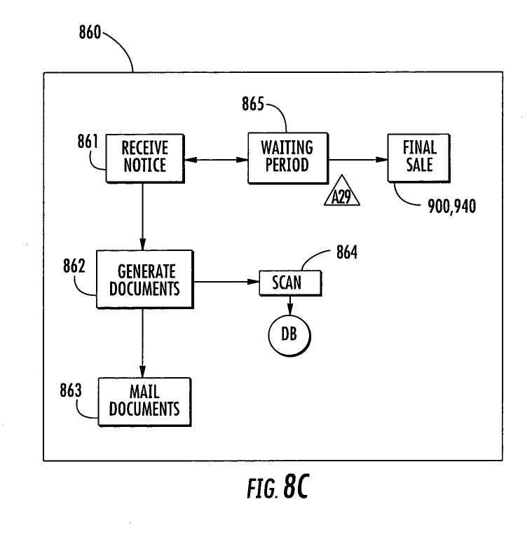

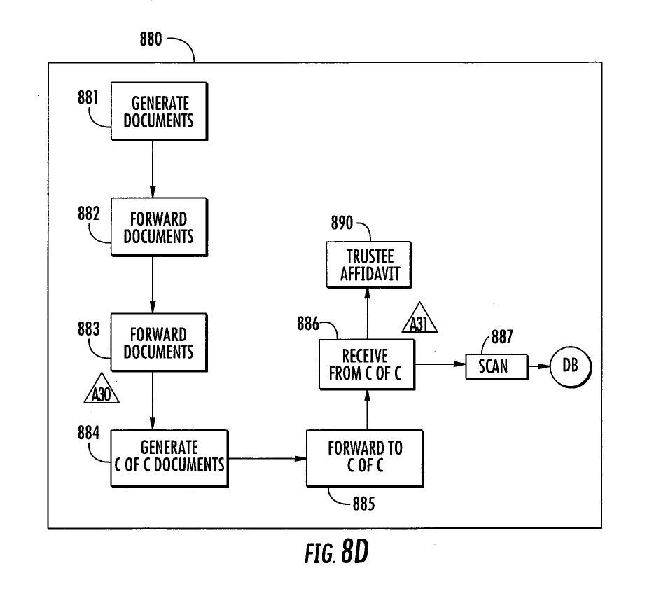

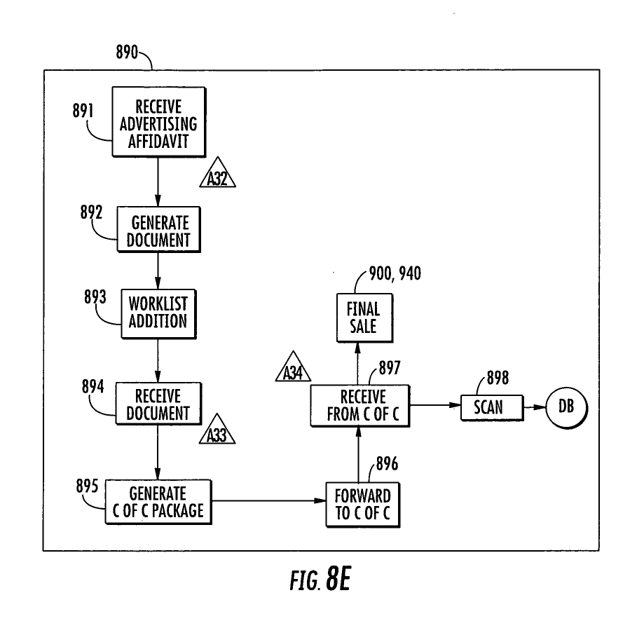

With reference to FIG. 8A, the foreclosure sale process 800 will now be described. In step 802, “Reports of Foreclosure Sale” can be generated by the system for the setting of the bid amount by the bank. Prior to the sale date, a request for protective bid amount from the bank can be made as in step 804, and an alarm A22 can be provided to automatically notify the paralegal if the protective bid amount has not been received by the bank within a certain amount of time (e.g., one day prior to sale). The “Reports of Foreclosure Sale” with the protective bid amount can then added to the local agent's (or sale attendee's) worklist as in step 806. In step 808, the local agent or title analyst conducts an additional title search update conducted from the date of the last title search update. An alarm A23 can be provided to automatically notify the paralegal if the title check has not been completed by the local agent within a certain time period before the sale date (e.g., one day before the sale date). In step 810; if the sale is not postponed, then the matter can move to process 840 (FIG. 8B) described hereinbelow. Otherwise (property not deeded out or no other interested parties identified), the process can move to step 812 wherein the sale can be conducted and attended by all necessary parties. It is noted that the “Reports of Foreclosure Sale” is typically read, filed and posted at the sale and then is filed with the Clerk of Courts as in step 814. Upon receipt of the filed “Reports of Foreclosure Sale”, the documents can be electronically scanned and e-filed in database DB as in step 816, if applicable. An alarm A24 can be provided to automatically notify the paralegal if the sales results and filed copy of the “Reports of Foreclosure Sale” are not received within a certain amount of time (e.g., one day after the sale date).

Referring further to FIG. 8A, if the purchaser at the sale in step 812 is a third party purchaser, step 818 can involve the receipt of a deposit from the third party purchaser, and step 822 can involve sending this deposit to an accounting department. After the sale in step 812 is completed, a statutorily imposed waiting period, typically ten days, can be conducted as in step 824 in order to determine if any upset bids (e.g., bids 5% higher than the one received at sale) are received. A query can be electronically made in step 826 to determine if any upset bids are received during the waiting period of step 824. An alarm A26 can be provided to automatically notify the paralegal once the waiting period (e.g., ten days) has expired since the sale date with no upset bids received. If an upset bid is received, the matter can continue to process 860 described below. If no upset bids are received, the process can continue to step 828 wherein the previous bid received can be assigned. If the bid has been assigned, the matter can continue to process 880 described below. If the bid has not been assigned, then the matter can move forward to the final sale of process 900 (bank purchaser) or 940 (third party purchaser), also described below.

With reference to FIG. 8B, if step 810 determines a need to postpone, then the matter can continue to process 840 for postponement or amendment of the sale. In step 841, a new sale date can be selected and this new sale date can be placed electronically on the matter calendar as in step 842. In step 843, a query can be run electronically based on statutorily imposed time periods. For instance, the query can determine if the date of the action is less than ninety days than the original sale date, and if so, then a new sale date can be chosen that is at least twenty-five days from the date of the action and the process can proceed to step 844. If though it is determined that the date of the action is greater than ninety days from the original date of sale, then the process can proceed to step 845. In step 844, a “Notice of Postponement of Foreclosure Sale” can be generated by the system, and in step 845 an “Amended Notice of Sale” document can be automatically generated by the system.

Referring further to FIG. 8B, if a postponement is required, the process can proceed to step 844 for generation of the “Notice of Postponement of Foreclosure Sale” as described above. If the newspaper ad did not run or was incorrect (step 847), if the purchaser defaults, or if the IRS letter was not sent within a statutorily determined time frame, for example twenty-five days, prior to the date of sale, then the process can continue to step 845. Whether the “Notice of Postponement of Foreclosure Sale” or the “Amended Notice of Sale” documents are generated by the system based on the above, the applicable document generation steps can be placed on the substitute trustee's worklist for generation, printing and signing as in step 848. In step 849, the signed documents can be returned from the substitute trustee, and an alarm A27 can be provided to automatically alert the paralegal if the signed documents are not received from the substitute trustee within a certain period of time (e.g., five days). In step 851, the system can generate the applicable Clerk of Courts documents for filing of the “Notice of Postponement of Foreclosure Sale” or “Amended Notice of Sale”, the Clerk of Courts documents including, for example, a cover letter, envelope, and a return envelope. In step 852, the relevant signed documents can be sent to the Clerk of Courts for filing of the documents, including, for example, an original of the document and two copies, and a return envelope for returning of the filed document. In step 853, the filed documents can be returned from the Clerk of Courts, and an alarm A28 can be provided if the filed documents are not received from the Clerk of Courts in a specific time frame (e.g., seven days). If applicable, the filed documents can be electronically scanned as in step 854 and e-filed in database DB, and the matter can continue back to process 700 for implementation of the notice of foreclosure sale described hereinabove.

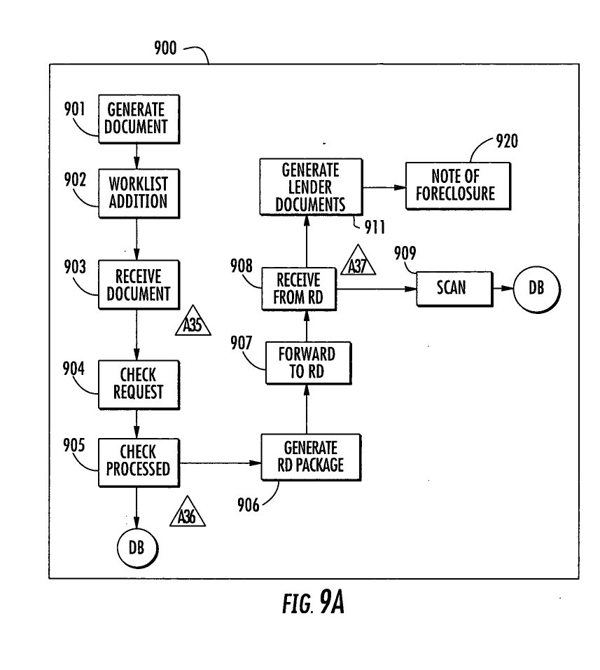

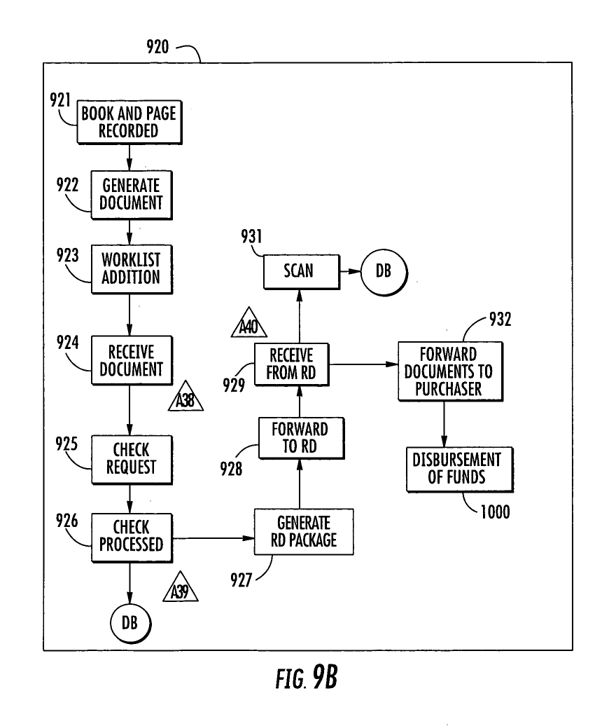

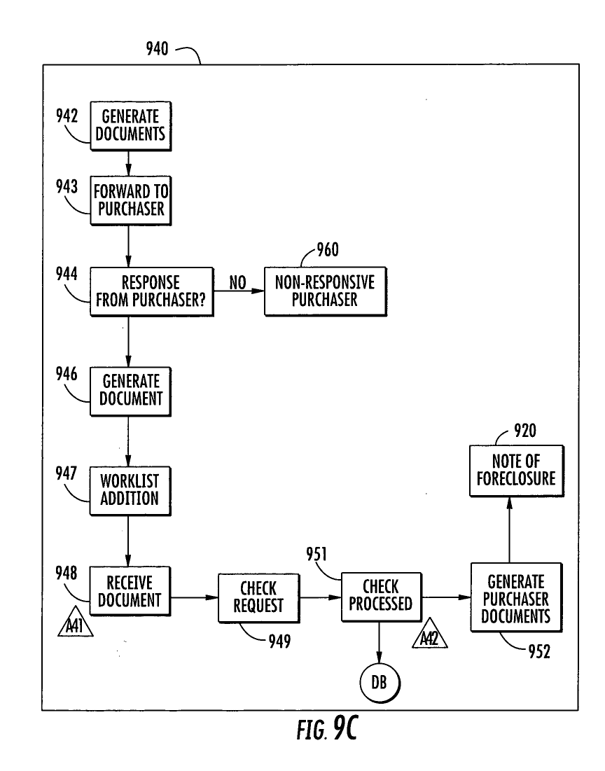

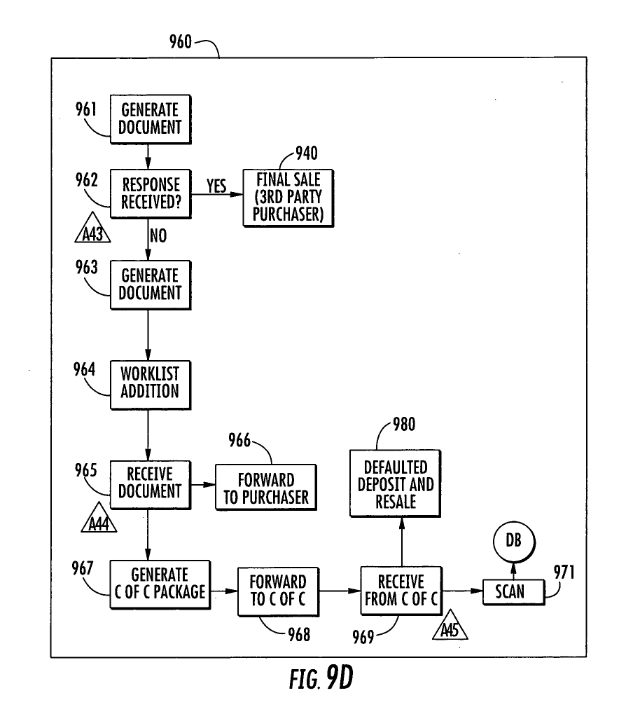

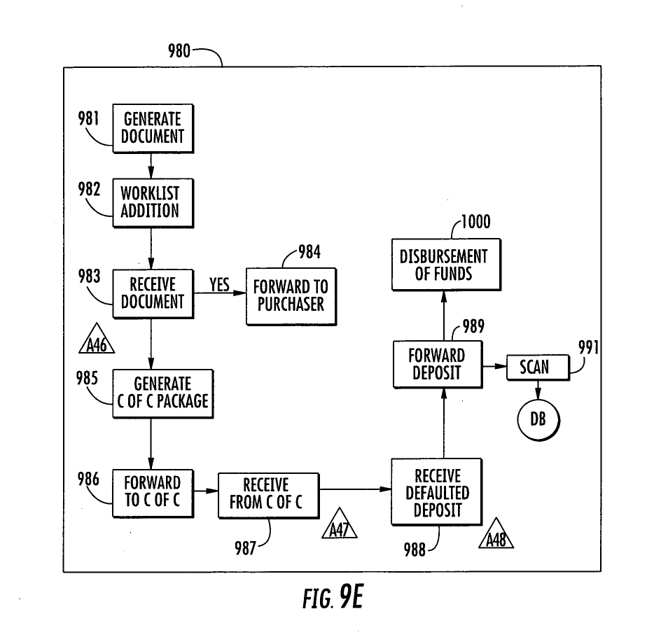

If an upset bid is received (step 826 above, FIG. 8A) in the waiting period of step 824, then the upset bid process 860 can be conducted as shown with reference to FIG. 8C. The upset bid process can begin in step 861 with the receipt of an upset bid notice from the Clerk of Courts. Although statutorily defined, the upset bid often must be received less than or equal to ten days, for example, from the sale date or less than or equal to ten days from the last upset bid date. An alarm A29 can be provided to automatically alert the paralegal if no upset bids are received during this time frame (with reference to step 865 below). Upon receipt of the upset bid notice, the system can generate an applicable cover letter as in step 862, and the “Notice of Upset Bid” and cover letter can be mailed to all interested parties, including the last highest bidder, as in step 863. In step 864, a copy of the cover letter and “Notice of Upset Bid” can be electronically scanned and e-filed in database DB as applicable. Once the “Notice of Upset Bid” has been mailed to all interested parties, another waiting period for the statutorily imposed time period (e.g., ten days) can be conducted as in step 865 to determine if any other upset bids are received. It is understood that there can be multiple upset bidders during the ten-day waiting period, and each upset bid must generally be a five percent increase over the amount of the previous bid. The waiting period clock can start with each upset bid, and the process can be allowed to proceed to final sale (see FIG. 9A if bank is purchaser or FIG. 9C if third party purchaser) as desired, for example after there have been no upset bids for ten days (or other statutorily defined time period). Once the waiting period of step 865 has been completed, the matter can move to final sale of process 900 for bank purchaser or process 940 for a third party purchaser, both processes of which are described in more detail further below.

Referring to FIG. 8D, bid assigned process 880 can be conducted if determined in step 828 (see FIG. 8A). The bid assigned process can begin with step 881 wherein the “Assignment of Bid” and cover letter documents can be generated by the system. In step 882, the documents generated in step 881 can be mailed to the highest bidder for signature along with return envelope materials. In step 883, the signed documents can be received from the highest bidder, and an alarm A30 can be provided to automatically alert the paralegal if the documents are not received from the highest bidder within a certain amount of time (e.g., five days). Upon receipt of the signed documents, Clerk of Courts documents including a cover letter, envelope, and return envelope can be generated by the system as in step 884, and the documents can be mailed to the Clerk of Courts (including an original executed copy of the “Assignment of Bid” and two copies) for filing as in step 885. In step 886, the filed documents can be received from the Clerk of Courts, and an alarm A31 can be provided to automatically alert the paralegal if the filed documents are not received from the Clerk of Courts within a certain amount of time (e.g., seven days). If applicable, the recorded documents can be electronically scanned and e-filed in database DB as in step 887 and the matter continues to process 890 described below.

Referring to FIG. 8E, process 890 can involve the processing of trustee affidavit documents before the final sale. In step 891, the representative can receive an advertising affidavit from the newspaper with a copy of the “Notice of Foreclosure Sale” as advertised. An alarm A32 can be provided to automatically alert the paralegal if the advertising affidavit is not received from the newspaper within a certain time frame after the sale date (e.g., ten days). In step 892, a generate “Trustee Affidavit” step can be placed on the substitute trustee's worklist for generating, printing and signing as in step 893. In step 894, the signed “Trustee Affidavit” can be received from the substitute trustee, and an alarm A33 can be provided to automatically alert the paralegal if the signed documents are not received from the substitute trustee within a certain period of time (e.g., five days). Upon receipt of the “Trustee Affidavit”, the “Trustee Affidavit Package” generation step 895 is completed including generation of a cover letter, envelope, and return envelope, and the “Trustee Affidavit” documents can be forwarded to the Clerk of Courts for filing as in step 896. In step 897, the filed “Trustee Affidavit” can be received from the Clerk of Courts, and an alarm A34 can be provided if the filed documents are not received within a certain amount of time (e.g., seven days). If applicable, the filed “Trustee Affidavit” can be electronically scanned and e-filed in database DB as in step 898, and the matter can proceed to process 900 of final sale (bank purchaser) or process 940 of final sale (third party purchaser).

Referring to FIG. 9A, if the lender bank is the purchaser at the foreclosure sale then process 900 can be implemented for the final sale. In step 901 of this process, a generate “Trustee Deed” step can be placed on the substitute trustee's worklist as in step 902. In step 903, the signed “Trustee Deed” can be received from the substitute trustee, and an alarm A35 can be provided to automatically alert the paralegal if the signed documents are not received from the substitute trustee within a certain amount of time (e.g., five days). In step 904, a check request for recordation of the “Trustee Deed” can be made to an accounting department, and in step 905 the accounting department can process the check request and forward to the paralegal and the check can be electronically scanned and e-filed in database DB if applicable. An alarm A36 can be provided if the check is not received from the accounting department within a specified time frame (e.g., one day). Once the check is received, the paralegal can generate an applicable Register of Deeds package including a cover letter, envelope, and a return envelope as in step 906, and in step 907 the original “Trustee Deed” and two copies, the cover letter, envelope, and return envelope can be sent to the Register of Deeds for recordation of the document. In step 908, the recorded “Trustee Deed” can be received from the Register of Deeds, and an alarm A37 can be provided to automatically alert the paralegal if the recorded documents are not received back from the Register of Deeds within a certain period of time (e.g., thirty days). If applicable, the recorded “Trustee Deed” documents can be electronically scanned and e-filed in database DB as in step 909. In step 911, the system can generate a cover letter to the lender for forwarding a copy of the recorded “Trustee Deed”, and the matter can move forward to process 920 for generation of the “Note of Foreclosure of Deed of Trust” as described below.

Referring to FIG. 9B, the generation to recordation of a “Notice of Foreclosure of Deed of Trust” can be composed within process 920. Process 920 can begin with step 921 wherein the “Trustee Deed” book and page recordation information can be entered into the system. In step 922, a generate “Notice of Foreclosure of Deed of Trust” step can be placed on the substitute trustee's worklist for generation, printing, and signature as in step 923. In step 924, the signed “Notice of Foreclosure of Deed of Trust” can be received from the substitute trustee, and an alarm A38 can be provided if the signed documents are not received back from the substitute trustee within a certain amount of time (e.g., five days). In step 925, a check request for recordation of the “Notice of Foreclosure of Deed of Trust” can be made to an accounting department, and in step 926 the accounting department can process the check and forward to the paralegal to electronically scan it and e-file a copy of the check with database DB if applicable. An alarm A39 can be provided to automatically alert the paralegal if the check has not been received from the accounting department within a certain amount of time (e.g., one day).

Referring further to FIG. 9B, documents for forwarding the “Notice of Foreclosure of Deed of Trust” to the Register of Deeds for recordation can be generated and can include a cover letter, envelope, and a return envelope as in step 927. In step 928, the original “Notice of Foreclosure of Deed of Trust” and two copies, the cover letter, envelope, and return envelope can be sent to the Register of Deeds for recordation. In step 929, the recorded “Notice of Foreclosure of Deed of Trust” can be received from the Register of Deeds, and an alarm A40 can be provided to automatically alert the paralegal if the recorded document is not received within a certain amount of time (e.g., thirty days). The recorded document can be electronically scanned and e-filed in the database DB if applicable as in step 931. The original “Notice of Foreclosure of Deed of Trust” can then be forwarded to the purchaser of the property or the purchaser's attorney as in step 932. At this point, the matter can move to process 1000 for disbursement of funds as will be discussed further hereinbelow.

Referring to FIG. 9C, process 940 can involve the final sale of the property if purchased by a third party purchaser (i.e., someone different from the lender). In step 942, a “Notice to Buyer Closing Letter” can be generated by the system, and in step 943 a copy of this document, along with a copy of the “Report of Foreclosure Sale” and “Notice of Sales” and a return envelope, can be forwarded to the third party purchaser for signature. A query can be run electronically in step 944 to determine if the signed documents are returned from the purchaser. If they are not returned, the matter can move to process 960 of final sale with no response from purchaser, the process of which is discussed further below. If the signed documents are received from the purchaser, the system next can generate a “Trustee Deed” as in step 946, and this document can be placed on the substitute trustee's worklist for signature as in step 947. In step 948, the signed documents can be received from the substitute trustee, and an alarm A41 can be provided to notify the paralegal if the signed documents are not received from the substitute trustee within a certain amount of time (e.g., five days). In step 949, a check request to cover revenue stamps and excise tax, if applicable, can be made to an accounting department, and in step 951 the accounting department can process the check request and issue a check that can be electronically scanned and e-filed in database DB if applicable. An alarm A42 can be provided to automatically notify the paralegal if the check is not received within a certain amount of time (e.g., one day). In step 952, the system can generate a cover letter to the purchaser or the purchaser's closing attorney for forwarding a copy of the “Trustee Deed”, and the matter can move to process 920, described above.

If the determination made in query step 944 described with reference to FIG. 9C above is that there is no response from the purchaser, then the matter can move to process 960 described herein with reference to FIG. 9D. In step 961 of this process, a “10 Day Letter” (or other statutorily imposed time period letter) can be generated by the system and forwarded to the non-responsive purchaser. Once the “10 Day Letter” is sent, a waiting period (e.g., ten days) can be enacted in order to wait for a response from the purchaser. An alarm A43 can be provided to automatically alert the paralegal to the end of this ten day waiting period, and a query can be electronically run in step 962 to determine if a response was received from the purchaser in less than or equal to the ten day period. If the response is received from the purchaser in the required amount of time, the matter can revert back to process 940 for the completion of the final sale as described with reference to FIG. 9C above. If a response is not received within the required amount of time, the process can move to step 963 wherein a “Motion and Order for Resale and Forfeiture of Deposit” can be placed on the substitute trustee's worklist for generation, printing and signature as in step 964. In step 965, the signed document can be received from the substitute trustee, and an alarm A44 can be provided if the signed documents are not received from the substitute trustee within a certain amount of time (e.g., five days). Once the documents are returned from the substitute trustee, a copy of the documents can be sent to the non-responsive purchaser as in step 966 and Clerk of Courts documents consisting of a cover letter, envelope and return envelope can be generated by the system as in step 967 for forwarding of the original “Motion and Order for Resale and Forfeiture of Deposit” for filing. The original document, two copies, and a return envelope can be forwarded to the Clerk of Courts office as in step 968. In step 969, the filed documents can be received from the Clerk of Courts office, and an alarm A45 can be provided to automatically alert the paralegal if the filed documents are not returned in a certain amount of time (e.g., seven days). If applicable, the filed documents can then be electronically scanned and e-filed in database DB as in step 971, and the matter can proceed to process 980 as described below.

If there is a defaulted deposit and resale of the property due to purchaser's default, the final sale process can end as process 980 with reference to FIG. 9E. In step 981, a “Motion and Order Allowing Disbursement of Defaulted Deposit” can be placed on the substitute trustee's worklist for generation, printing and signature as in step 982. In step 983, the signed documents can be received from the substitute trustee, and an alarm A46 can be provided to automatically alert the paralegal if the documents are not received back from the substitute trustee in a certain amount of time (e.g., five days). Upon receipt of the signed documents, a copy of the documents can be forwarded to the defaulted purchaser as in step 984, and relevant documents for filing with the Clerk of Courts can be generated by the system as in step 985 including a cover letter, envelope and return envelope. In step 986, the original Motion and two copies can be forwarded with the return envelope to the Clerk of Courts for filing. In step 987, the filed documents can be received from the Clerk of Courts, and an alarm A47 can be provided if the filed documents are not returned from the Clerk of Courts within a certain amount of time (e.g., seven days). If it is determined that the purchaser has in fact defaulted, the purchase deposit can be received from the Clerk of Courts as in step 988. An alarm A48 can be provided to automatically notify the paralegal if the purchase deposit has not been received from the Clerk of Courts within a certain amount of time (e.g., fifteen days). Upon receipt of the purchase deposit, the deposit can be sent to an accounting department to be held for disbursement, and if applicable, the deposit can be electronically scanned and e-filed in database DB as in step 991. At this point, the matter can proceed to process 1000 for the disbursement of funds as described below.

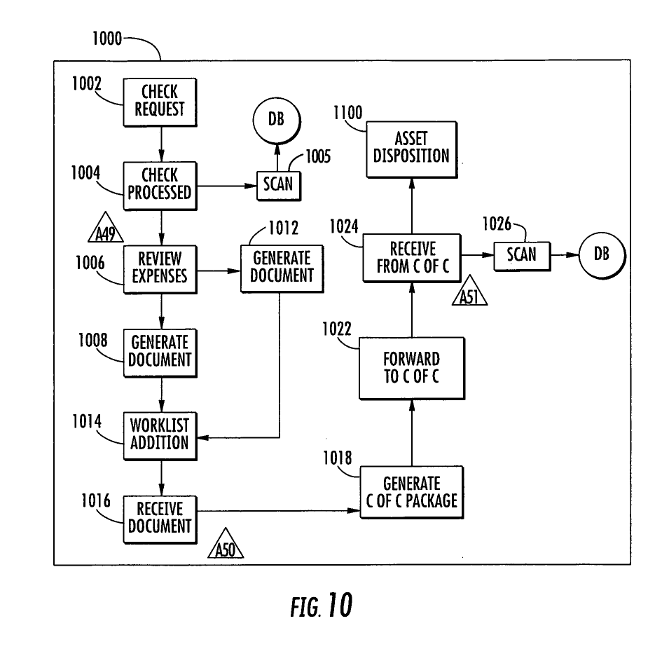

Referring now to FIG. 10, once the foreclosure sale has been completed, process 1000 for the disbursement of funds can be initiated. During this process, in step 1002, a request can be made for a trust account check (if a third party purchaser) or a regular check (if a bank purchaser). This request can be made to an accounting department for forwarding to the Clerk of Courts for the clerk's commission, revenue stamps, excised tax, etc. In step 1004, the accounting department can process the check request and issue a check and, if applicable, electronically scan and e-file a copy in database DB as in step 1005. An alarm A49 can be provided to automatically alert the paralegal if the check has not been received from the accounting department in a certain amount of time (e.g., one day).

In step 1006, a review of all costs involved in the foreclosure sale, in correlation with the check received from the accounting department, can be made. In step 1008, a “Trustee's Affidavit of Disbursement” can be placed on the substitute trustee's worklist for generation, printing, and signature as in step 1014. Concurrently, a “Final Report and Account of Foreclosure Sale” can be generated as in step 1012 and placed on the substitute trustee's worklist for generation, printing and signing as in step 1014. In step 1016, the signed documents can be received from the substitute, and an alarm A50 can be provided to automatically alert the paralegal if the signed documents are not received from the substitute trustee within a specified time frame (e.g., five days). Upon receipt of the signed documents, relevant Clerk of Courts documents can be generated by the system in step 1018, including a cover letter, envelope, and return envelope. The original document, two copies of the document, the cover letter, check, and return envelope can be forwarded to the Clerk of Courts for filing as in step 1022. In step 1024, the filed documents can be received from the Clerk of Courts, and an alarm A51 can be provided to automatically alert the paralegal if the documents are not returned from the Clerk of Courts within a certain amount of time (e.g., seven days). If applicable, the filed documents can be electronically scanned and filed in database DB as in step 1026. The matter can then move to process 1100 for asset disposition as described below.

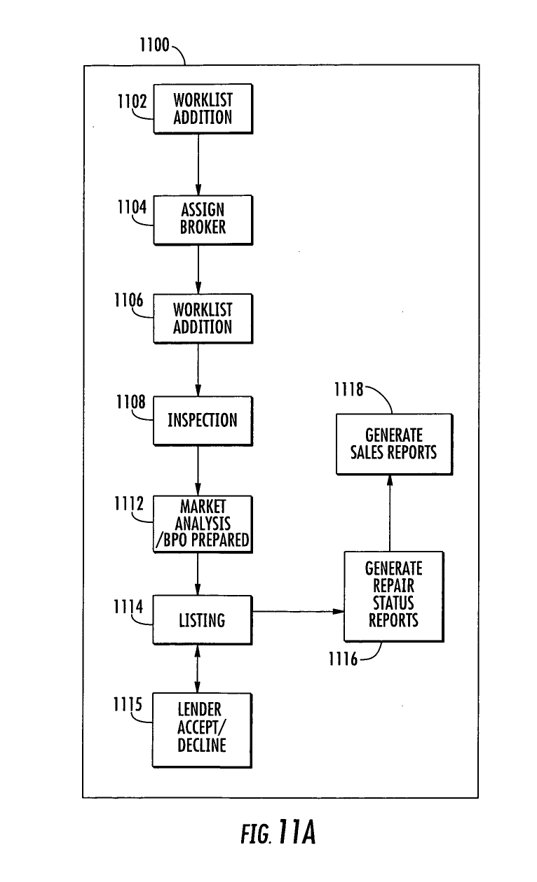

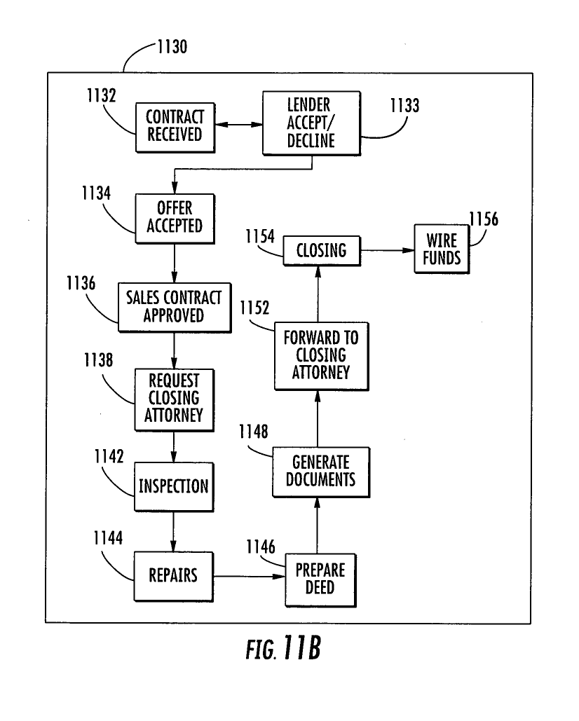

With reference to FIG. 11A, in a situation where the purchaser at the foreclosure sale is the bank itself, the property asset then can be disposed of as in process 1100. In this process, in step 1102, the specifications of the property can be forwarded by the system to the assigned realtor's worklist. In step 1104, the realtor can assign a broker, and the property specifications can be forwarded electronically to the broker's worklist as in step 1106. In step 1108, the property can be inspected, and a market analysis can be performed in step 1112 and a Broker's Price Opinion entered into the system. In step 1114, the realtor electronically suggests a listing price based on comparable properties. The lender can electronically accept or decline the suggested listing price as in step 1115. If declined, the lender will be prompted by the system to counter listing. The realtor can withdraw a listing at any time. The lender must accept the listing before the offer step can commence. Expense estimates can be submitted for approval (or withdrawn) and the lender must approve or reject all expenses over a certain threshold (e.g., $250.00). Once expenses have been approved, the realtor must track vendor payments and electronically submit all payments to accounting for batch processing. The attorney can receive a weekly expense report that typically must be approved before accounting will process the expense batch and generate a reimbursement check. Estimates, expenses, and approval and reimbursement status can be reviewed at the matter level or at the client level at any time in the process. Expenses typically cannot be submitted after the asset closing date. In step 1116, the system can track the status of repairs and expenses as may be indicated in the property inspection of step 1108, and in step 1118 monthly reports of comparables and sales in the area surrounding the subject property can be reviewed. When a potential offer is made and pending sale is anticipated, the process can move to process 1130 for the asset disposition sale as described below.

With reference to FIG. 11B and step 1130, multiple offers can be submitted by the realtor as in step 1132. The lender can accept or counter one offer. The other offers are automatically withdrawn unless an offer is rejected. Once an offer has been accepted as in step 1134, a sales contract is submitted by the realtor and approved by the lender. In step 1138, a request for a closing attorney can be made, the property can be inspected as in step 1142, and any repairs can be made to the property as required as in step 1144. Closing documents, such as deed and lien waiver documents, can be prepared as in step 1146 and in step 1148 a letter to the closing attorney, with instructions for these documents, is generated and is sent to the closing attorney as in step 1152. The property closing can be conducted in step 1154, and the funds received at the closing for the disposition of the property asset can be wired to the bank in step 1156 for closing of the matter.

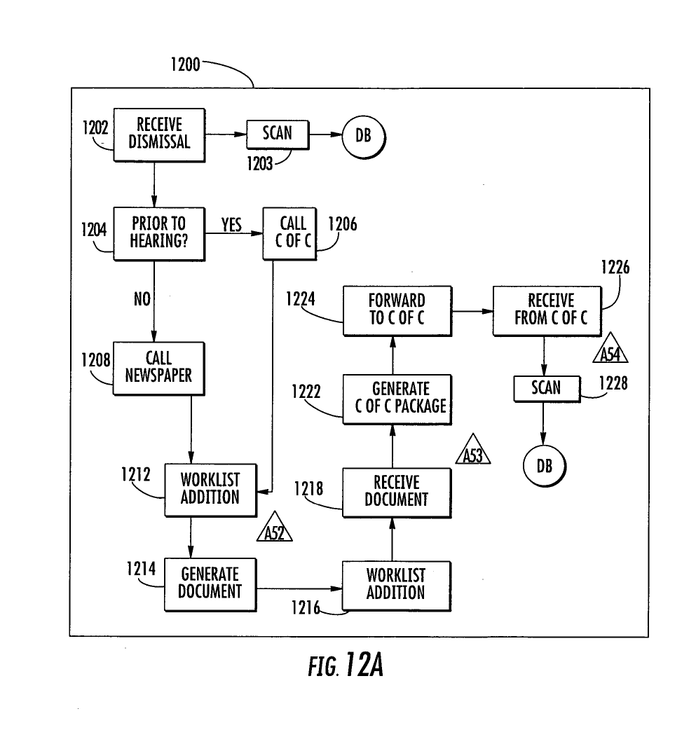

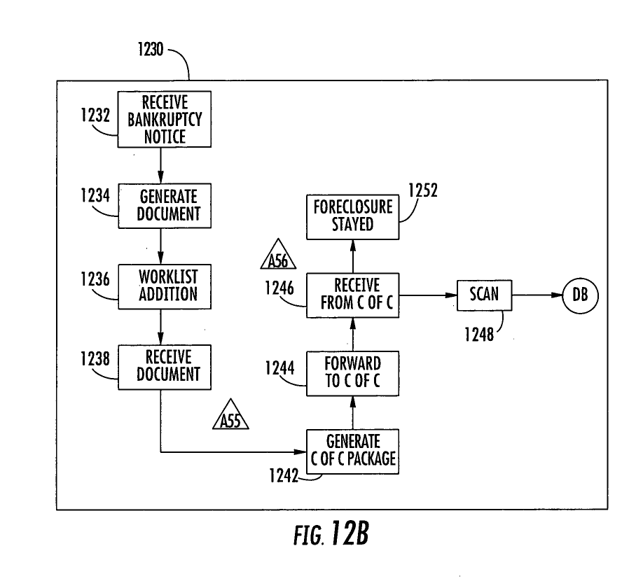

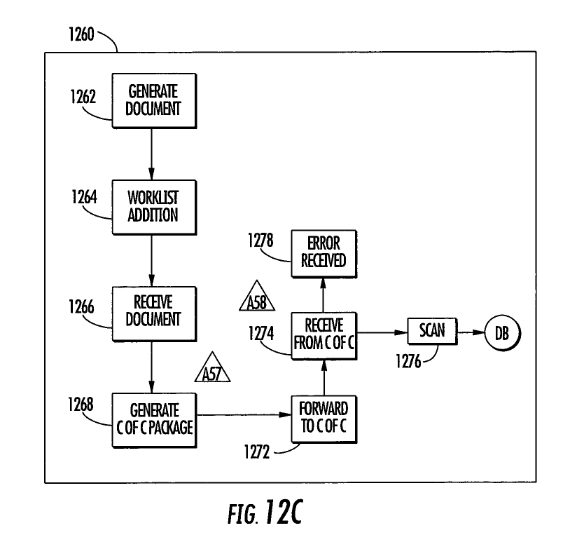

While the methods, systems, and computer program products of the present subject matter can be most appropriately used therein in the foreclosure sale process and described in reference to process 200-1000 described above, there are also various contingencies that may occur during a foreclosure proceeding and that can be handled or managed by the subject matter disclosed herein. As described further below, these contingency processes can include, for example, a dismissal of foreclosure 1200 (see FIG. 12A), bankruptcy 1230 (see FIG. 12B), and foreclosure error 1260 (see FIG. 12C).

With reference to FIG. 12A, the first contingency can involve the dismissal of the foreclosure with reference to process 1200. In step 1202, the “Dismissal of Foreclosure Notice” can be received by the representative and, if applicable, can be electronically scanned and e-filed in database DB as in step 1203. Step 1204 can involve an electronic query to determine if the dismissal notice was received prior to the foreclosure hearing or after the foreclosure hearing. If the dismissal notice is received prior to the hearing, the Clerk of Courts can be contacted in order to cancel the hearing as in step 1206. If the dismissal notice was received after the hearing, the newspaper can be contacted to cancel the “Notice of Foreclosure Sale” as in step 1208. After the conducting of either step 1206 or 1208, an electronic inquiry is placed on the substitute trustee's worklist to determine whether the dismissal was with or without prejudice as in step 1212, and a response from the substitute trustee to the representative can be made. An alarm A52 can be provided to alert the paralegal if the response to this inquiry is not received from the substitute trustee within a certain amount of time. In step 1214, a “Notice of Dismissal” document can be placed on the substitute trustee's worklist for generation, printing and signing as in step 1216. In step 1218 the signed documents are received from the substitute trustee, and an alarm A53 can be provided to automatically alert the paralegal if the signed documents are not returned from the substitute trustee within a certain amount of time (e.g., five days). In step 1222, relevant Clerk of Courts documents can be generated by the system for filing of the documents, including a cover letter, envelope, and return envelope. The original and two copies of the documents can be sent to the Clerk of Courts, along with the cover letter, envelope and the return envelope as in step 1224. In step 1226, the filed documents can be received from the Clerk of Courts, and an alarm A54 can be provided if the filed documents are not received from the Clerk of Courts within a certain amount of time. In step 1228, the filed documents can be electronically scanned and e-filed in database DB as applicable. A matter may be undismissed or reactivated. If so, the process can copy all the matter information to a new matter and place the new matter on the paralegal's worklist for review and approval. The new and old matters are therefore linked.

With reference to FIG. 12B, a second contingency of bankruptcy involves process 1230. In step 1232 of this process, a bankruptcy notice can be received and the relevant information, such as bankruptcy case number and date of filing, can be entered into database DB. In step 1234, a “Notice of Bankruptcy” document can be generated by the system and placed electronically on the substitute trustee's worklist for printing and signing as in step 1236. In step 1238, the signed documents can be received from the substitute trustee, and an alarm A55 can be provided if the signed documents are not received from the substitute trustee within a certain amount of time (e.g., five days). In step 1242, applicable Clerk of Courts documents can be generated by the system including a cover letter, envelope, and return envelope, and an original and two copies of the documents with the cover letter and return envelope can be sent to the Clerk of Courts as in step 1244. In step 1246, the filed documents can be received from the Clerk of Courts, and an alarm A56 can be provided to automatically alert the paralegal if the filed documents are not received from the Clerk of Courts within a specified time period. If applicable, the filed documents can be electronically scanned and e-filed in database DB as in step 1248. In step 1252, the foreclosure proceedings can be stayed until receipt of an order lifting the stay pending the disposition of the bankruptcy proceeding.

Referring to FIG. 12C, a third contingency of foreclosure error can involve process 1260. In this process, step 1262 can include the generation of a “Quitclaim Deed” to be placed on the substitute trustee's worklist for generation, printing and signing as in step 1264. In step 1266, the signed document can be received form the substitute trustee, and an alarm A57 can be provided to automatically alert the paralegal if the signed documents have not been received by the substitute trustee. In step 1268, relevant Clerk of Courts documents can be generated by the system including a cover letter, envelope, and return envelope, and the original document and two copies, with the cover letter and return envelope, can be sent to the Clerk of Courts as in step 1272. In step 1274, the filed documents can be received from the Clerk of Courts, and an alarm A58 can be provided to alert the paralegal if the filed documents are not received from the Clerk of Courts within a specified time frame. If applicable, the filed documents can be electronically scanned and e-filed in database DB as in step 1276. At this point, the matter is manually set back to the point of error workflow step as determined by the paralegal.

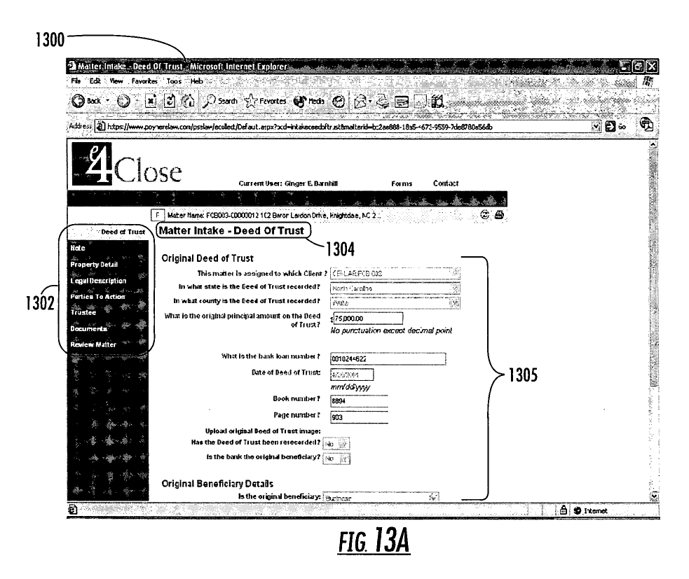

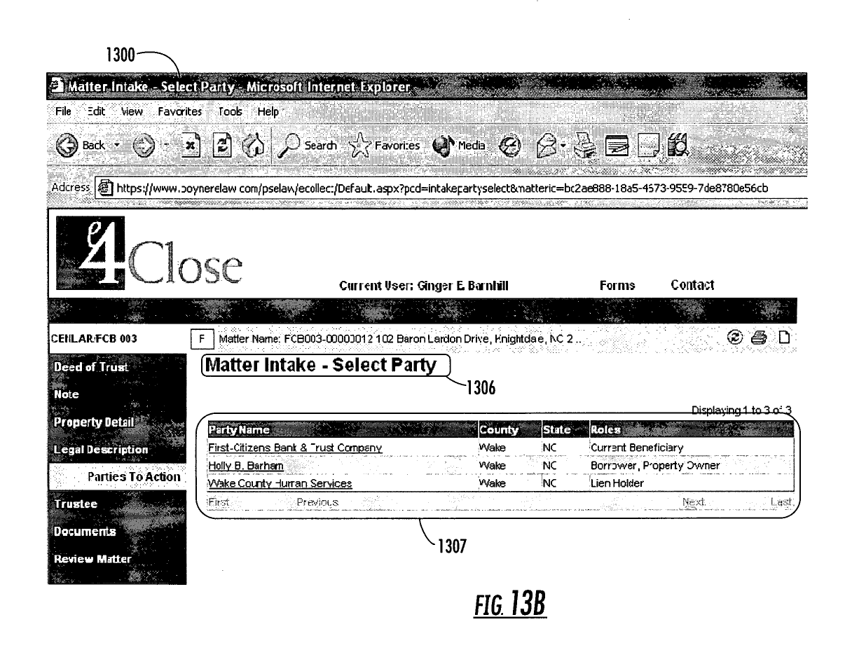

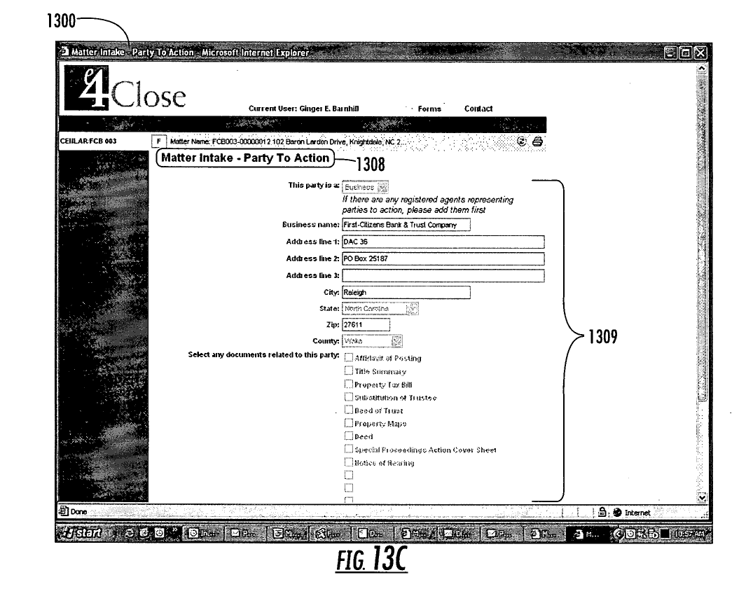

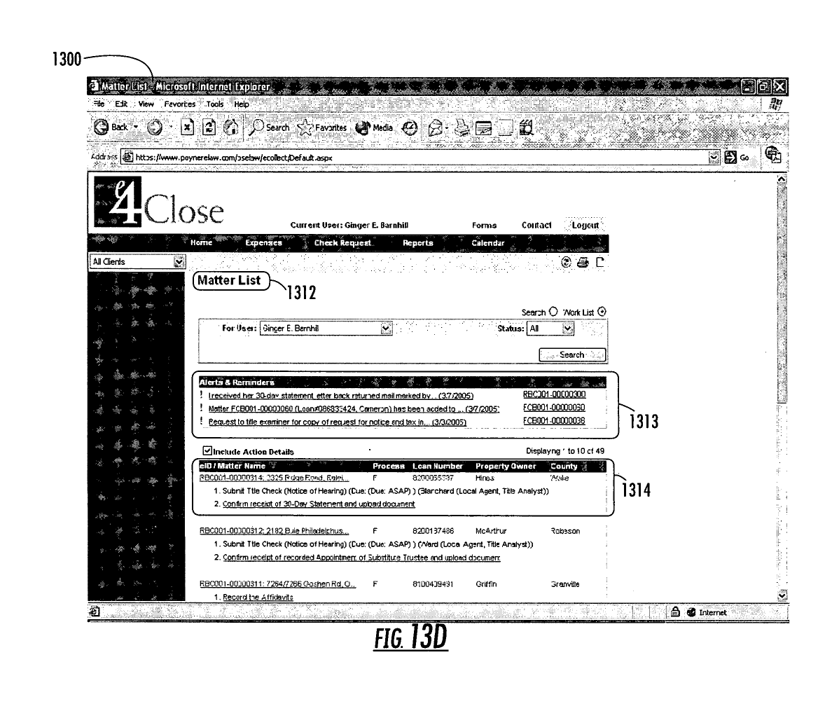

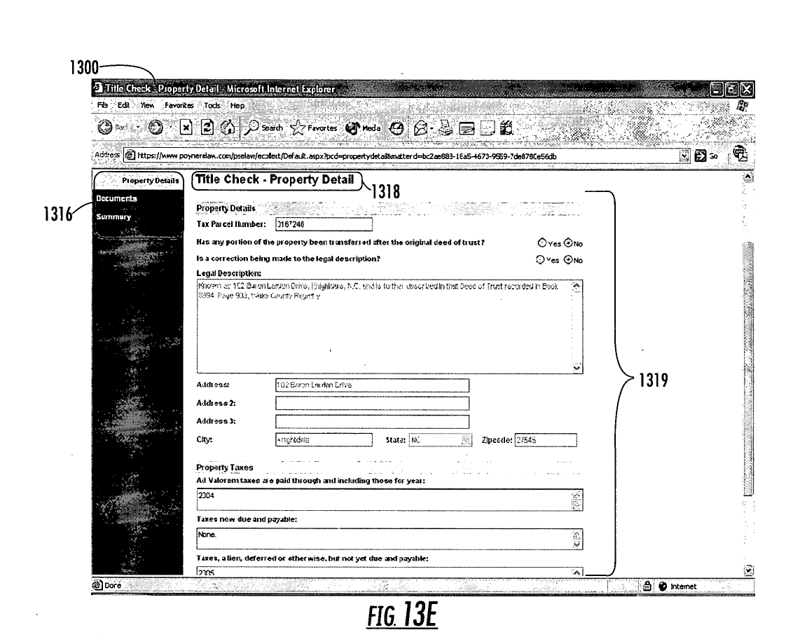

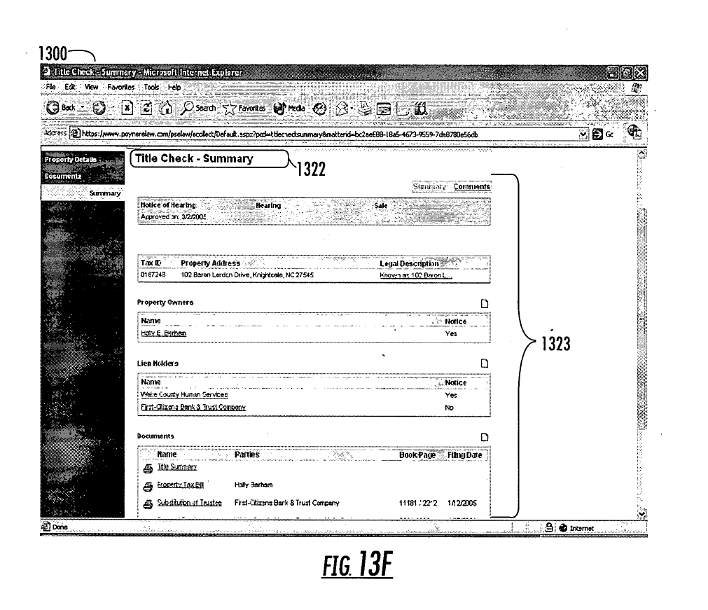

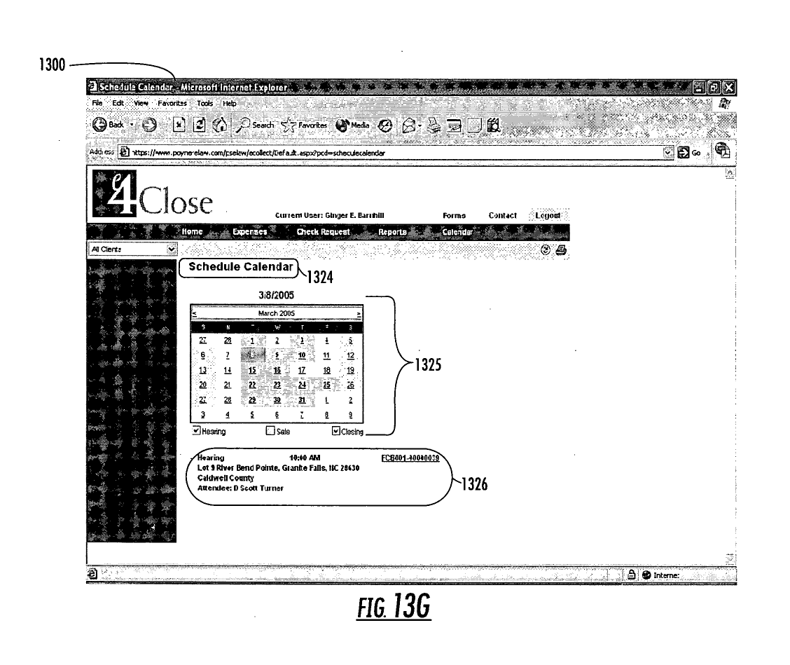

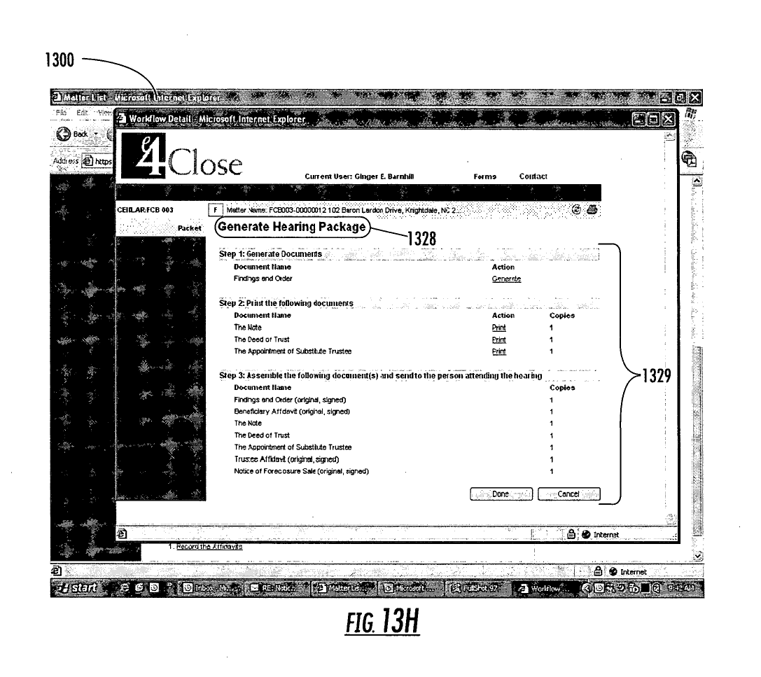

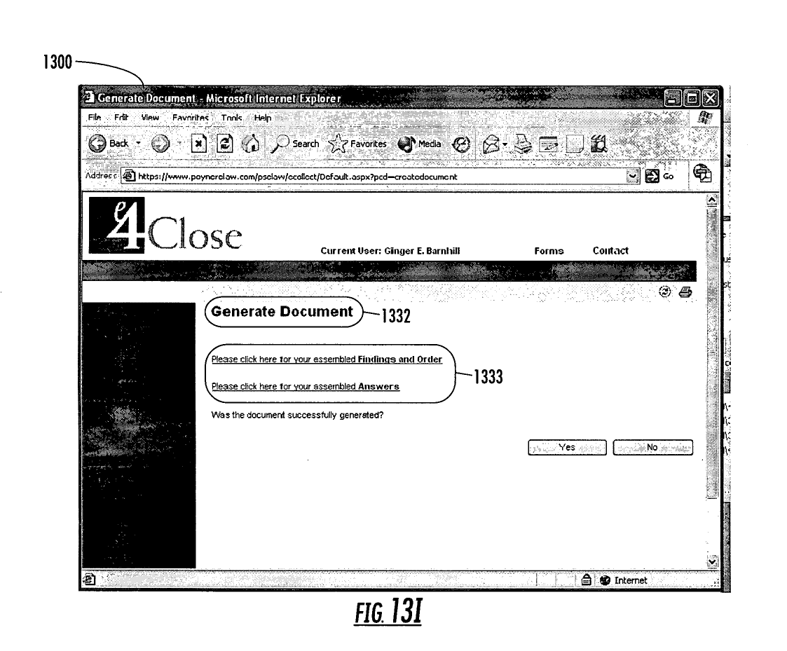

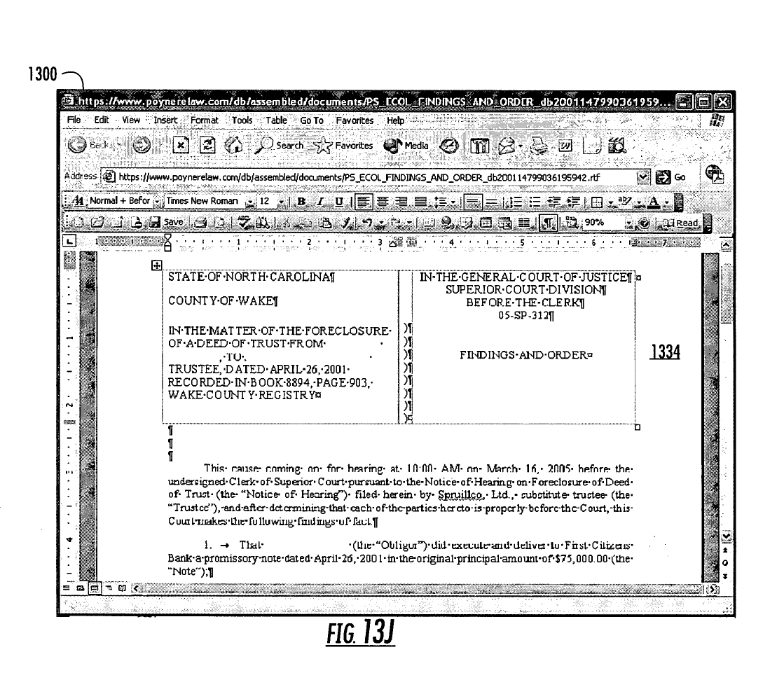

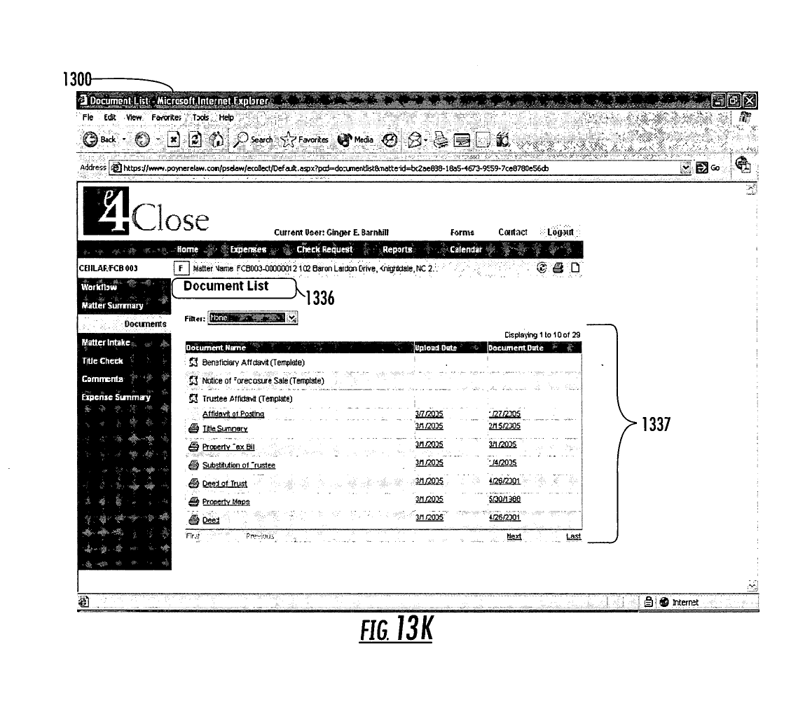

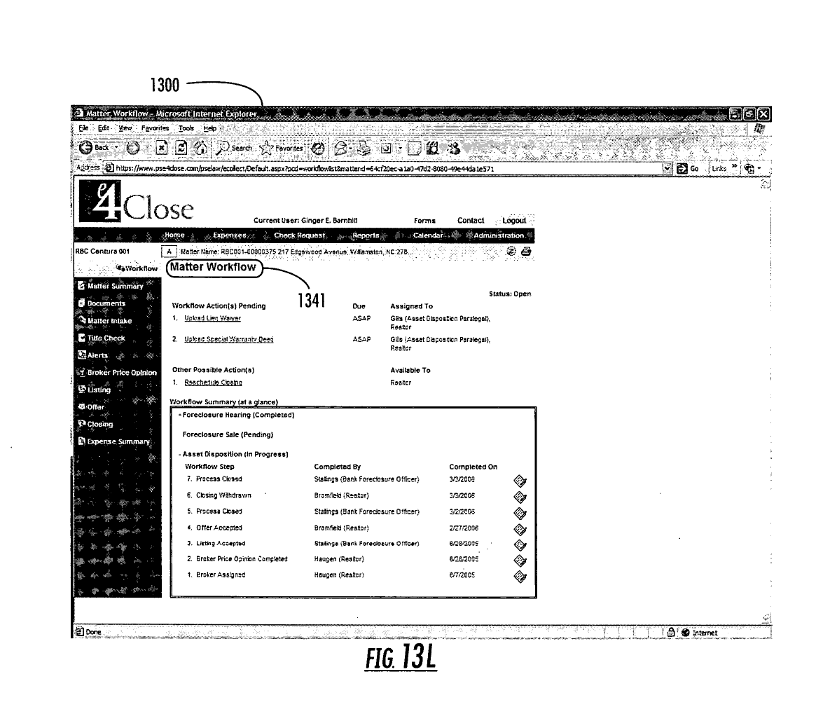

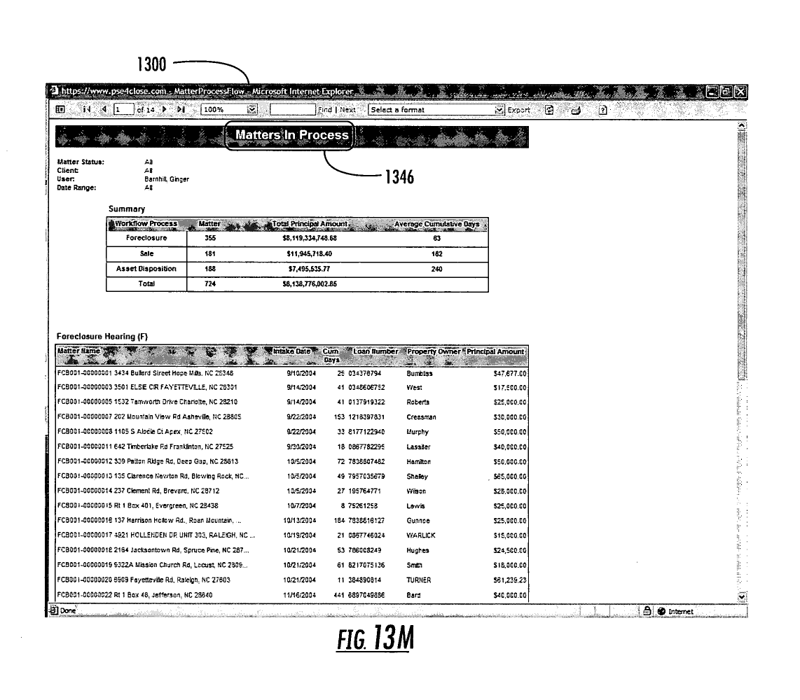

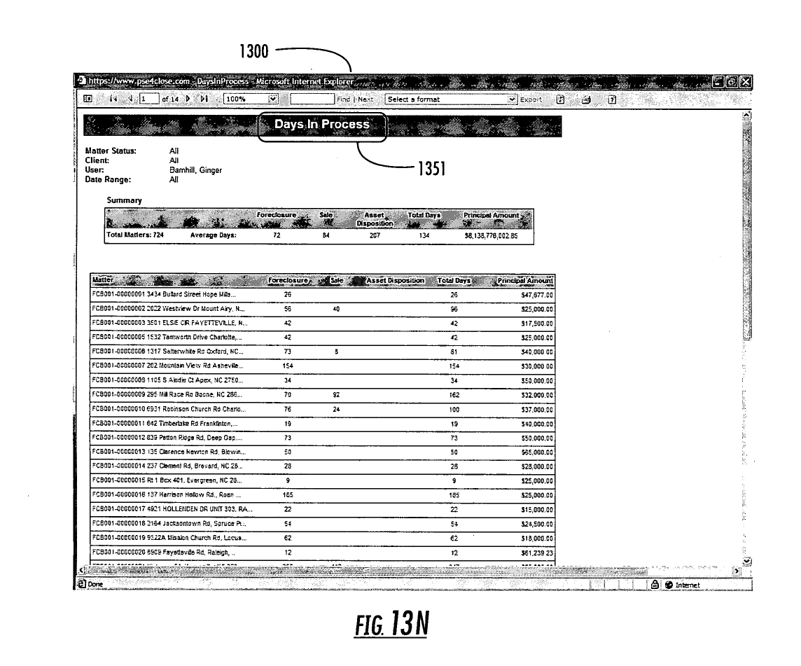

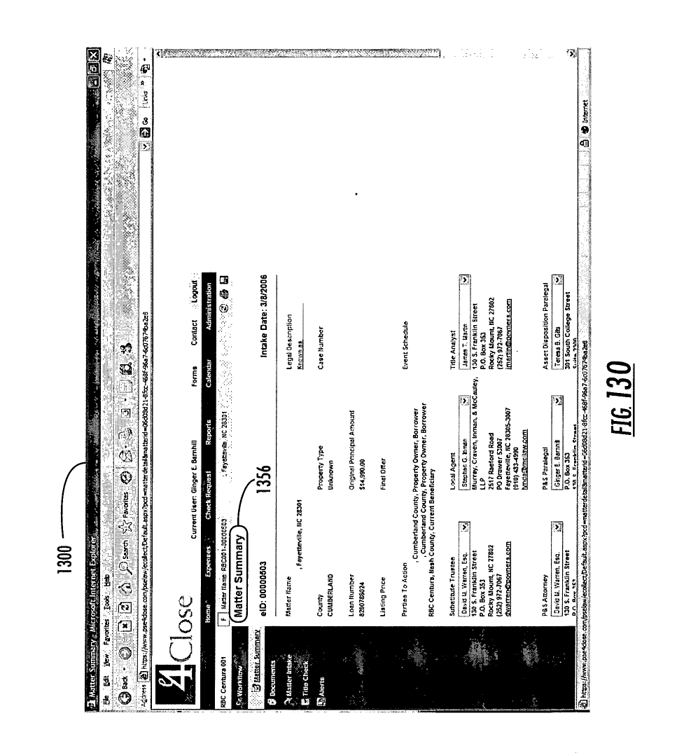

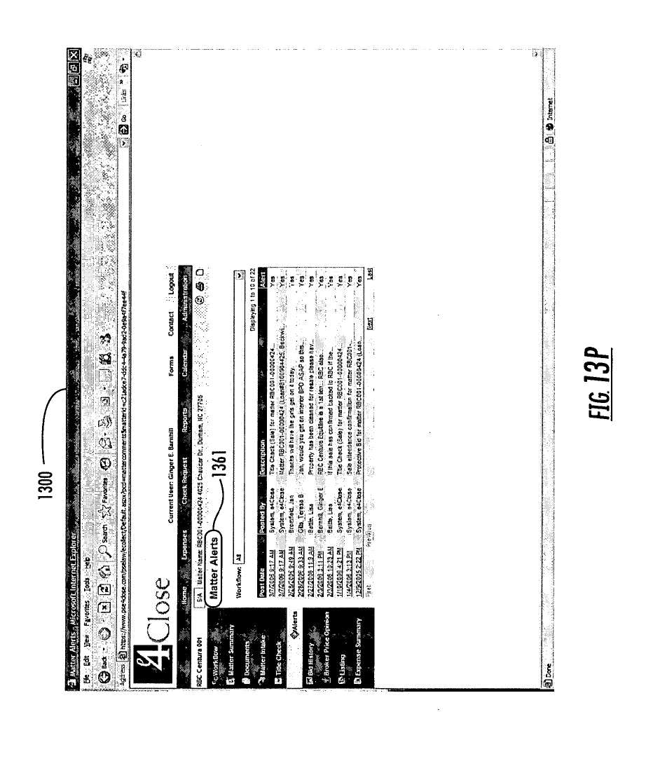

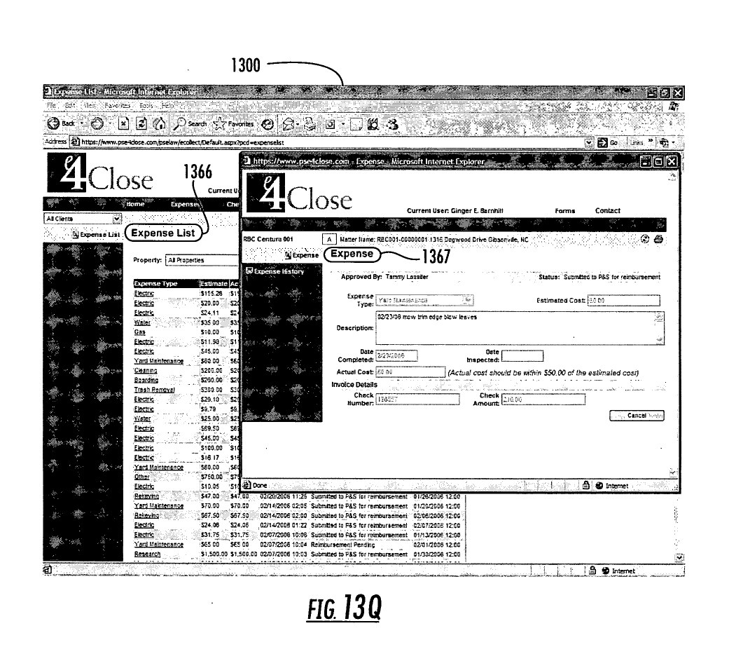

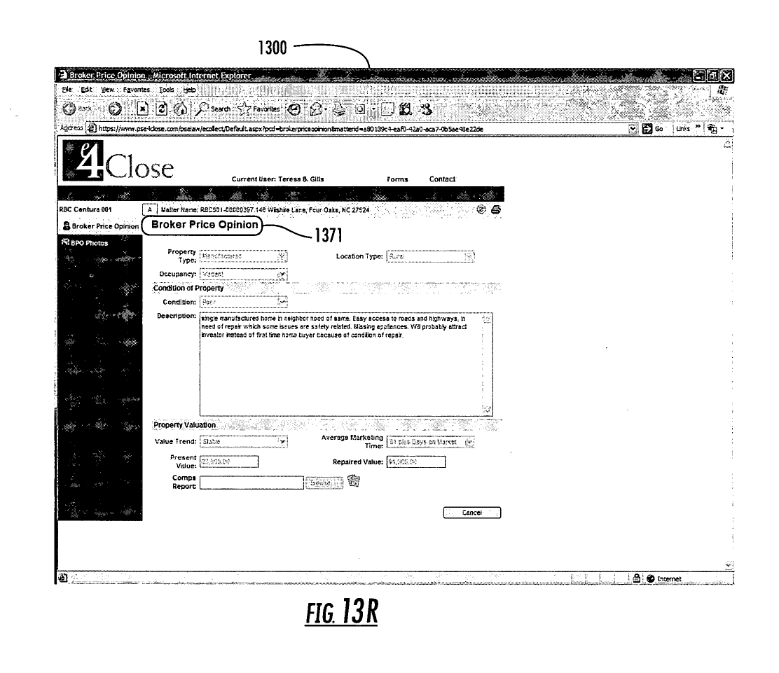

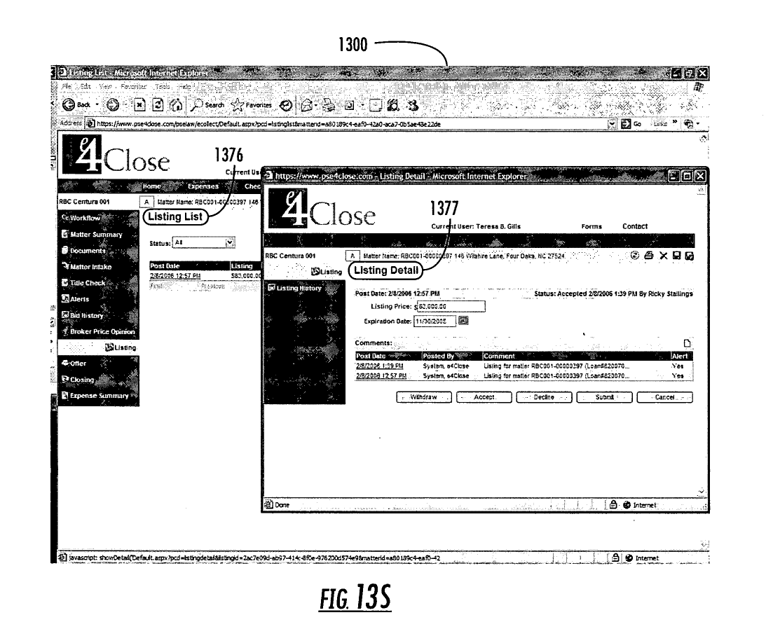

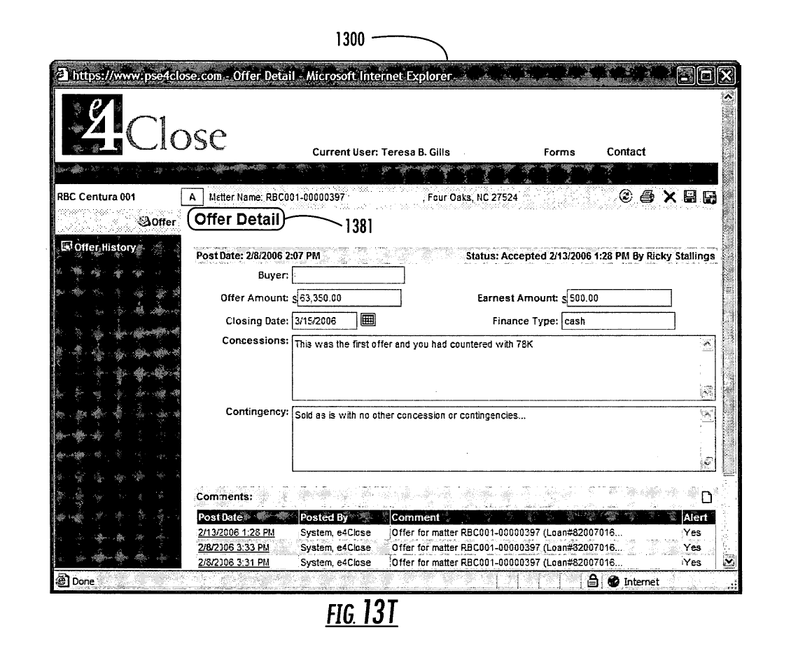

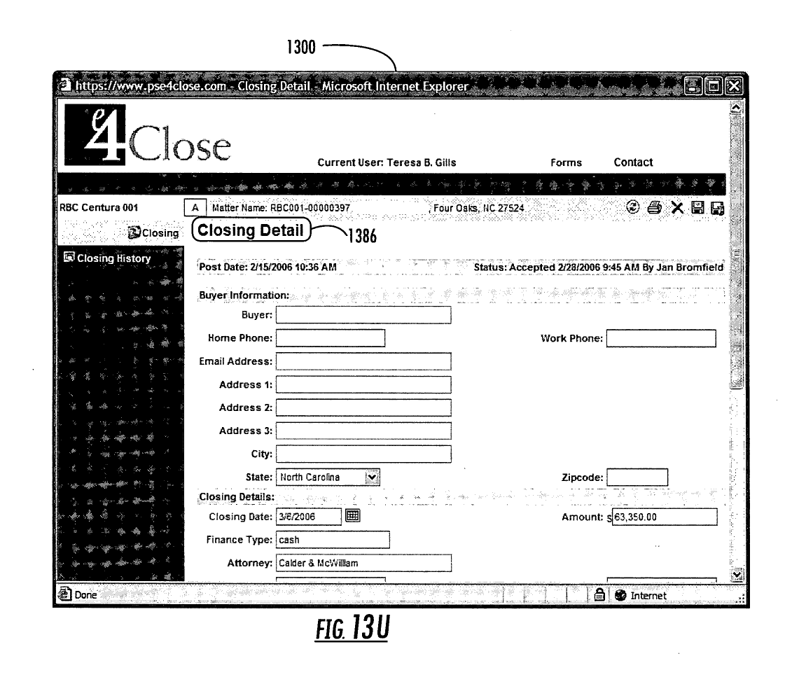

With reference to FIGS. 13A-13U, illustrative examples are shown of an HTML browser window 1300, such as that used as a graphic user interface on a global computer network, displaying various hypertext pages on a user's computer during the automatic foreclosure process of the present subject matter.

FIGS. 13A-13C show exemplary computer screens (HTML) related to, for example, matter intake 200 discussed above. With reference to FIG. 13A, during this process the system can provide, for example, a menu 1302 for information collected at intake, including the deed of trust, the note, the legal description of the property, parties to the action, and the trustee, as well as documents related to this information. Specific sub-items of menu 1302 can be selected wherein pages for specific information, such as information on the deed of trust 1304, can be accessed by the user. Referring to FIG. 13B, the menu item of parties to the action can include a sub-item for review of parties 1306 if there is more than one party to the action wherein a list 1307 can be provided to review multiple parties. In FIG. 13C, the party to the action sub-item 1308 can be provided wherein party specific information 1309 can be reviewed by the user.

FIG. 13D is an exemplary example of a Matter List 1312 which can be provided by the system for displaying of alerts or alarms 1313 and worklists 1314 as described above (such as, for example, with reference to alarm A1 and step 204 in matter intake 200). The matter list page can allow the creation of new matters, search functionality, Alerts and Reminders and a to-do list sorted by deadline. Different views can be presented for different roles and can be based on login-credentials. Matters can be displayed only if the matter is associated with the user. Various colors can be used for different indicators. For example, matters displayed in green can indicate a task is due by the user. Red can indicate a task is overdue. Black can indicate that the matter is on another users' Task List. Additionally, if “Include Action Details” is selected, the matter grid can be expanded to display a hyperlink to the next workflow step and the responsible party.

FIGS. 13E and 13F show exemplary HTML pages related to, for example, step 214 of matter intake 200 discussed above. As shown in FIG. 13E, a menu 1316 can be provided with title check information such as property details, documents available, and a summary. The property detail sub-item 1318 can include, for example, information 1319 such as property details, property taxes, etc. As shown in FIG. 13F, the title check summary sub-item 1322 can include various information as may relate to a routine property title search or check during the process of a foreclosure matter.

FIG. 13G is an exemplary example of an HTML page relating to, for example, step 408 of the scheduling of the foreclosure hearing sale and closing 400. Once schedule dates are entered into the system, the user can query electronically the schedule calendar information 1324 in order to view a calendar 1325. The user can click on various dates to see relevant information 1326 related to that date and link back to the relevant matters. The calendar can show foreclosure hearing and sale dates as well as the final asset sale (or closing) dates.

FIGS. 13H-13K show exemplary HTML pages related to document generation and storage, such as, for example, a “Findings and Order” document in step 603 above (part of the package of hearing documents). With reference to FIG. 13H, the system can provide a screen for the generation of certain documents, such as that for generating a hearing package 1328. Item list 1329 can be available for generation of documents, such as a “Findings and Order” document, printing of documents associated with the document to be generated, and assembling of all documents for the complete package. FIG. 131 illustrates an HTML page that can be produced when the generate documents item from list 1329 is selected. This can include generate document header 1332 and selections 1333 for various actions to be performed. FIG. 13J is an example of the generated document, namely the “Findings and Order” document 1334, generated upon command (or automatically as applicable) from previously filed information. FIG. 13K illustrates a document list 1336 which can contain documents 1337 generated by the system or scanned and uploaded into the system during the foreclosure process. Additional documents can be added. Details about the documents can be displayed and any document can be viewed and printed. Different document types can contain different document details related to the document. Automatically generated documents can be regenerated.

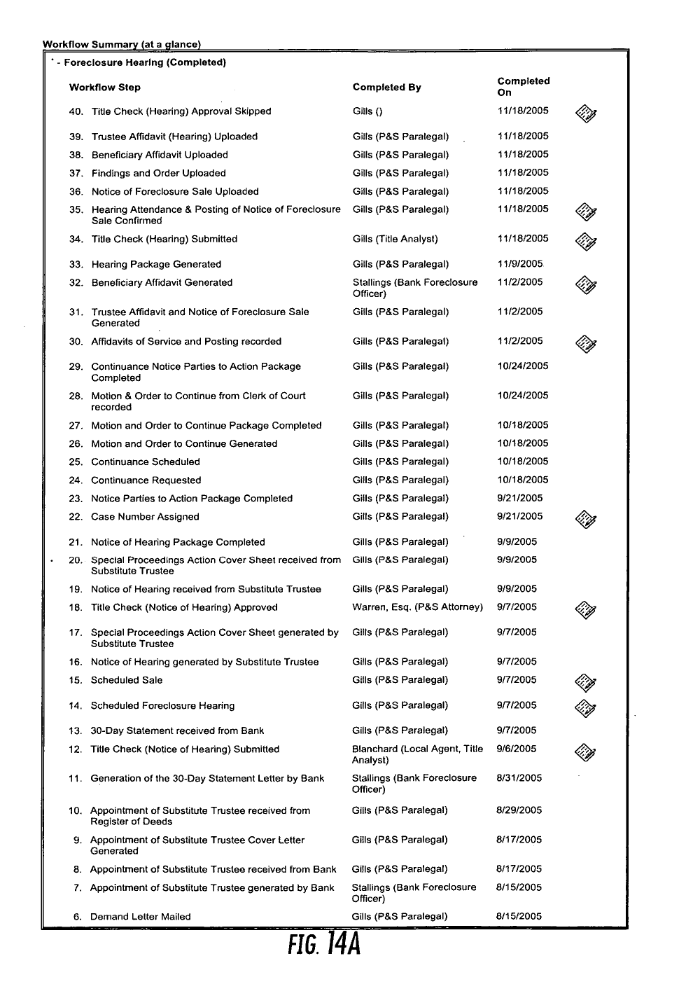

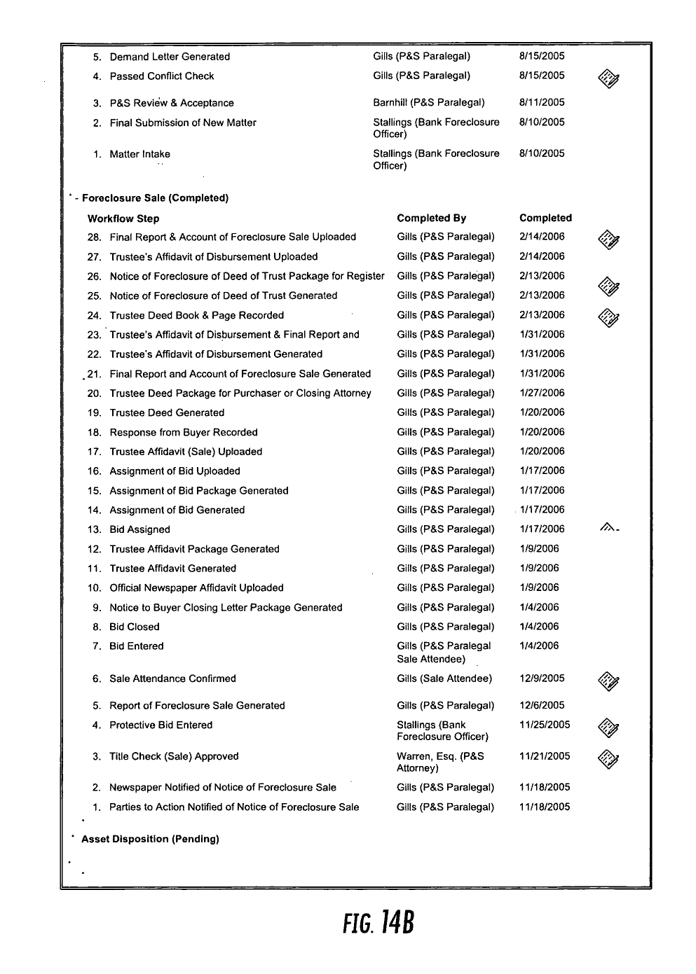

FIG. 13L is an exemplary example of a Matter Workflow 1341 listing which can be provided by the system for displaying workflow actions pending, other possible actions, and a workflow summary (described in more detail in relation to FIGS. 14A-14B below).

FIGS. 13M and 13N relate to two reports, Matters in Process 1346 and Days in Process 1351, respectively, which can be included. These reports can generate details about the number of matters in foreclosure, total dollar amount involved, average time from beginning to end of the foreclosure process, etc. The reports can be generated by client, user, matter status, and intake date range, and each report can contain a summary. The Matters in Process Report Summary 1346 (see FIG. 13M) can display each workflow process, how many matters are in each process and the cumulative average days. The user can also move to the different sections of the report by clicking on the process name. The Days in Process Summary 1351 (see FIG. 13N) can display the average days in each process and the total average days in process. Details about the matters in each process can be displayed and hyperlink directly to the matter workflow screen 1341 discussed above. The reports can also be exported in a number of formats.

FIG. 13O is an example of a Matter Summary 1356 which can be provided by the system for displaying basic information about the matter and the responsible parties assigned. This summary can provide limited administrative capabilities to reassign responsible parties.

As discussed above, automatic system-generated alerts and reminders can be displayed at the top of the Matter List, sent as an email with a link to the matter, or both. With reference to FIG. 13P, manual alerts can also be generated from the Matter Alerts 1361 screen and transmitted in the same manner. System or manual alerts can be displayed on the Alerts screen. Alerts can be associated with a workflow process or the matter in general. The Alerts screen can display the comment, date posted, posted by, who it was sent to and whether it was sent as an email or displayed on the Matter List 1312 (see FIG. 13D), or both.

With reference to FIG. 13Q, and as discussed above, expenses can be tracked in an Expense List 1366 for all matters that are in asset disposition. The lender can approve or reject all expense estimates over a certain threshold, such as $250. Estimates vs. actual expenses of individual expenses 1367 can be tracked. The lender can accept or reject any expense that exceeds the approved estimate. Expenses incurred by the realtor can be submitted for reimbursement and, if approved by the attorney, can be sent to accounting for batch processing. Expense details and history can also be recorded.

FIGS. 13R-13U are exemplary HTML pages related to various other processes that can be conducted. FIG. 13R illustrates a page associated with Broker Price Opinion 1371, which can include information related to a broker price opinion such as property condition and property valuation. FIG. 13S illustrates a page associated with a property listing and can include a Listing List 1376 and narrower Listing Detail 1377. FIG. 13T illustrates a page associated with a property offer and can include an Offer Detail 1381 including offer information such as buyer, offer amount, closing date, concessions, and contingencies. FIG. 13U illustrates a page associated with a property closing and can include a Closing Detail 1386 including all details of a closing transaction.

FIGS. 14A-14B show exemplary HTML pages related to a typical summary of workflow items which can display the flow of the matter through the foreclosure process. Pending tasks can be displayed along with other possible actions which are conditional on the current process. The items can be displayed by history and grouped by process and the items can be in any preferred sequence (or chronological order) with information such as status, responsible party, etc. Comment icons related to individual workflow items can also be linked to the item summary for a user's ready reference.

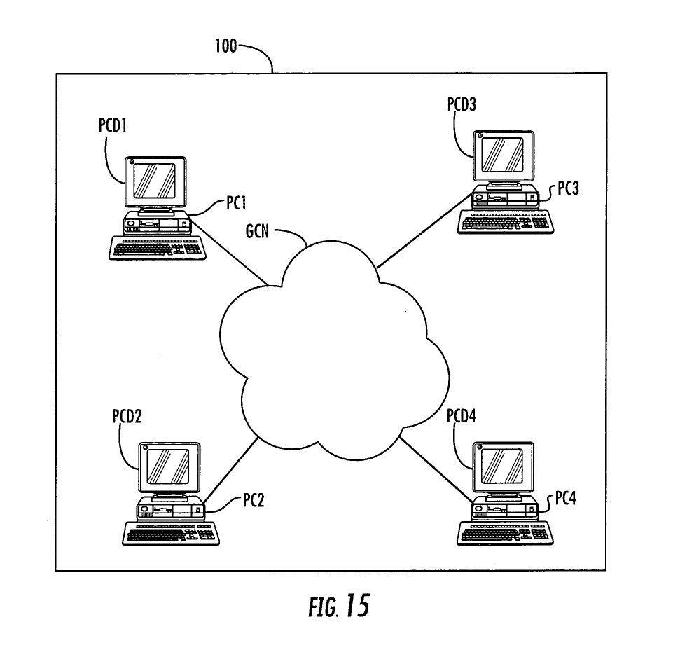

Referring to FIG. 15, the methods, systems, and computer program products related to automated foreclosure process 100 described above can be securely conducted over a global computer network GCN. Any suitable number of computers, such as personal computers PC1-PC4 with displays PCD1-PCD4, respectively, can be provided and communicate over global computer network GCN for carrying out the automated foreclosure process described herein. For example, information and documents can be generated and transmitted and received between personal computers PC1-PC4. It is also envisioned that the automated foreclosure process could be carried out over a closed secure network. Personal computers PC1-PC4 can represent, for example and without limitation, computers for personnel involved in a foreclosure process. For example, the computers can be used by one or more paralegals and/or attorneys, a substitute trustee, a local agent, a bank officer, and/or a real estate agent/broker. It is also envisioned that processes that have in the past been non-electronic can now or in the future be electronically automated in accordance with the present automated foreclosure process.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. An automated foreclosure method comprising:
a) providing a data inquiry for receiving user input relating to a foreclosure matter;
b) in response to the data inquiry, retrieving information over a data network relating to the foreclosure matter;
c) generating documents relating to the foreclosure matter either automatically or in response to a document request; and
d) presenting information at least comprising tracking information relating to the foreclosure matter.

2. The method according to claim 1 wherein the step of providing a data inquiry for receiving user input comprises providing a data inquiry for receiving user input relating to a mortgage loan and real property associated with the mortgage loan.

3. The method according to claim 1 wherein the step of presenting information comprises presenting real-time information.

4. The method according to claim 3 wherein the step of presenting information comprises providing a worklist on a user computer for step-by-step real-time tracking of the foreclosure matter.

5. The method according to claim 1 wherein the step of presenting information comprises presenting inquiry and/or reporting information relating to the foreclosure matter.

6. The method according to claim 1 further comprising providing an electronic alert relating to the foreclosure matter of a deadline relating to the foreclosure matter.

7. An automated foreclosure method comprising:
a) collecting information relating to a foreclosure matter through a data network connected to multiple users associated with a foreclosure matter;
b) generating documents relating to the foreclosure matter either automatically or in response to a document request; and
c) presenting information at least comprising tracking information relating to the foreclosure matter.

8. The method according to claim 7 wherein the step of collecting information comprises collecting information relating to a mortgage loan and real property associated with the mortgage loan.

9. The method according to claim 7 wherein the step of presenting information comprises presenting real-time information.

10. The method according to claim 9 wherein the step of presenting information comprises providing a worklist on a user computer for step-by-step real-time tracking of the foreclosure matter.

11. The method according to claim 7 wherein the step of presenting information comprises presenting inquiry and/or reporting information relating to the foreclosure matter.

12. The method according to claim 7 further comprising providing an electronic alert of a deadline relating to the foreclosure matter.

13. A method for automating management of a foreclosure matter and providing web-based inquiry and reporting of the matter, the method comprising the steps of:
a) obtaining information relating to a foreclosure matter using a computerized inquiry form;
b) storing the obtained information in a network accessible database;
c) generating documents based upon the obtained information and providing online tracking of the generated documents; and
d) providing an electronic alert of a deadline relating to the foreclosure matter.

14. The method according to claim 13 wherein the step of obtaining information comprises obtaining information relating to a mortgage loan and real property associated with the mortgage loan.

15. The method according to claim 14 further comprising providing the foreclosure matter with a unique identification number once the mortgage loan information is obtained.

16. The method according to claim 13 further comprising recording a date and time stamp in a history table in the database each time a step or action is taken during the foreclosure matter.

17. The method according to claim 13 further comprising providing a worklist on a user computer for step-by-step tracking of the foreclosure matter.

18. A method for automating management of a foreclosure matter and providing web-based inquiry and reporting of the matter, the method comprising the steps of:
a) obtaining information relating to a foreclosure matter using a web-based inquiry form, the information including mortgage holder, mortgage loan, and property collateral information;
b) generating automated documents relating to the foreclosure matter, the documents based on the obtained information;
c) presenting the documents electronically to personnel involved with the foreclosure matter; and
d) presenting information at least comprising tracking information relating to the foreclosure matter.

19. The method according to claim 18 wherein the step of presenting information comprises presenting real-time information.

20. The method according to claim 19 wherein the step of presenting information comprises providing a worklist on a user computer for step-by-step real-time tracking of the foreclosure matter.

21. The method according to claim 18 wherein the step of presenting information comprises presenting inquiry and/or reporting information relating to the foreclosure matter.

22. The method according to claim 18 further comprising providing an electronic alert of a deadline relating to the foreclosure matter.

23. The method according to claim 18 further comprising providing the foreclosure matter with a unique identification number once the foreclosure matter information is obtained.

24. An automated foreclosure system comprising:
a) an inquiry form for receiving user input relating to a foreclosure matter;
b) a data network relating to the foreclosure matter for retrieving information in response to the data inquiry;
c) a document generator for generating documents relating to the foreclosure matter either automatically or in response to a document request; and
d) a display for presenting information at least comprising tracking information relating to the foreclosure matter.

25. The system according to claim 24 wherein the inquiry form comprises an inquiry form for receiving user input relating to a mortgage loan and real property associated with the mortgage loan.

26. The system according to claim 24 wherein the display for presenting information comprises a display for presenting real-time information.

27. The system according to claim 26 wherein the display for presenting information comprises a display for presenting a worklist for step-by-step real-time tracking of the foreclosure matter.

28. The system according to claim 24 wherein the display for presenting information comprises a display for presenting inquiry and/or reporting information relating to the foreclosure matter.

29. The system according to claim 24 further comprising an alert signal for providing an electronic alert of a deadline relating to the foreclosure matter.

30. A system for automating a foreclosure process, the system comprising:
a) a collector for collecting information relating to a foreclosure matter through a data network connected to multiple users associated with the foreclosure matter;
b) a document generator for generating documents relating to the foreclosure matter either automatically or in response to a document request; and
c) a display for presenting information at least comprising tracking information relating to the foreclosure matter.

31. The system according to claim 30 wherein the collector comprises a collector for collecting information relating to a mortgage loan and real property associated with the mortgage loan.

32. The system according to claim 30 wherein the display for presenting information comprises a display for presenting real-time information.

33. The system according to claim 32 wherein the display for presenting information comprises a display for presenting a worklist for step-by-step real-time tracking of the foreclosure matter.

34. The system according to claim 30 wherein the display for presenting information comprises a display for presenting inquiry and/or reporting information relating to the foreclosure matter.

35. The system according to claim 30 further comprising an alert signal for providing an electronic alert of a deadline relating to the foreclosure matter.

36. A system for automating management of a foreclosure matter and providing web-based inquiry and reporting of the matter, the system comprising:
a) a computerized inquiry form for obtaining information relating to a foreclosure matter;
b) a network accessible database for storing the obtained information;
c) a document generator for generating documents based upon the obtained information and for providing online tracking of the generated documents; and
d) an alert signal providing an electronic alert of a deadline relating to the foreclosure matter.

37. The system according to claim 36 wherein the computerized inquiry form comprises a computerized inquiry form for obtaining information relating to a mortgage loan and real property associated with the mortgage loan.

38. The system according to claim 37 further comprising an identifier for providing the foreclosure matter with a unique identification number once the mortgage loan information is obtained.

39. The system according to claim 36 further comprising a recorder for recording a date and time stamp in a history table in the database each time a step or action is taken during the foreclosure matter.

40. The system according to claim 36 further comprising a display for providing a worklist for step-by-step tracking of the foreclosure matter.

41. A system for automating management of a foreclosure matter and providing web-based inquiry and reporting of the matter, the system comprising:
a) a web-based inquiry form for obtaining information relating to a foreclosure matter, the information including mortgage holder, mortgage loan, and property collateral information;
b) a document generator for generating automated documents relating to the foreclosure matter, the documents based on the obtained information;
c) a transmitter for transmitting electronically the documents generated to personnel involved with the foreclosure matter; and
d) a display for presenting information at least comprising tracking information relating to the foreclosure matter.

42. The system according to claim 41 wherein the display for presenting information comprises a display for presenting real-time information.

43. The system according to claim 42 wherein the display for presenting information comprises a display for presenting a worklist for step-by-step real-time tracking of the foreclosure matter.

44. The system according to claim 41 wherein the display for presenting information comprises a display for presenting inquiry and/or reporting information relating to the foreclosure matter.

45. The system according to claim 41 further comprising an alert signal for providing an electronic alert relating to the foreclosure matter of a deadline relating to the foreclosure matter.

46. The system according to claim 41 further comprising an identifier for providing the foreclosure matter with a unique identification number once the foreclosure matter information is obtained.

47. A computer program product for automated foreclosure, the computer program product comprising computer executable instructions embodied in a computer readable medium for performing steps comprising:
a) providing a data inquiry for receiving user input related to a foreclosure matter;
b) in response to the data inquiry, retrieving information over a data network related to the foreclosure matter;
c) generating documents related to the foreclosure matter either automatically or in response to a document request; and
d) presenting information at least comprising tracking information relating to the foreclosure matter.

48. The computer program product according to claim 47 wherein the step of providing a data inquiry for receiving user input comprises providing a data inquiry for input relating to a mortgage loan and real property associated with the mortgage loan.

49. The computer program product according to claim 47 wherein the step of presenting information comprises presenting real-time information.

50. The computer program product according to claim 49 wherein the step of presenting information comprises providing a worklist on a user computer for step-by-step real-time tracking of the foreclosure matter.

51. The computer program product according to claim 47 wherein the step of presenting information comprises presenting inquiry and/or reporting information relating to the foreclosure matter.

52. The computer program product according to claim 47 further comprising providing an electronic alert of a deadline relating to the foreclosure matter.

53. A computer program product for automated foreclosure, the computer program product comprising computer executable instructions embodied in a computer readable medium for performing steps comprising:
a) collecting information relating to a foreclosure matter through a data network connected to multiple users associated with the foreclosure matter;
b) generating documents relating to the foreclosure matter either automatically or in response to a document request; and
c) presenting information at least comprising tracking information relating to the foreclosure matter.

54. The computer program product according to claim 53 wherein the step of collecting information comprises collecting information relating to a mortgage loan and real property associated with the mortgage loan.

55. The computer program product according to claim 53 wherein the step of presenting information comprises presenting real-time information.

56. The computer program product according to claim 55 wherein the step of presenting information comprises providing a worklist on a user computer for step-by-step real-time tracking of the foreclosure matter.

57. The computer program product according to claim 53 wherein the step of presenting information comprises presenting inquiry and/or reporting information relating to the foreclosure matter.

58. The computer program product according to claim 53 further comprising providing an electronic alert of a deadline relating to the foreclosure matter.

59. A computer program product for automating management of a foreclosure matter and providing web-based inquiry and reporting of the matter, the computer program product comprising computer executable instructions embodied in a computer readable medium for performing steps comprising:
a) obtaining information relating to a foreclosure matter using a computerized inquiry form;
b) storing the obtained information in a network accessible database;
c) generating documents based upon the obtained information and providing online tracking of the generated documents; and
d) providing an electronic alert of a deadline relating to the foreclosure matter.

60. The computer program product according to claim 59 wherein the step of obtaining information comprises obtaining information relating to a mortgage loan and real property associated with the mortgage loan.

61. The computer program product according to claim 60 further comprising providing the foreclosure matter with a unique identification number once the mortgage loan information is obtained.

62. The computer program product according to claim 59 further comprising recording a date and time stamp in a history table in the database each time a step or action is taken during the foreclosure matter.

63. The computer program product according to claim 59 further comprising providing a worklist on a user computer for step-by-step tracking of the foreclosure matter.

64. A computer program product for automating management of a foreclosure matter and providing web-based inquiry and reporting of the matter, the computer program product comprising computer executable instructions embodied in a computer readable medium for performing steps comprising:
a) obtaining information relating to a foreclosure matter using a web-based inquiry form, the information including mortgage holder, mortgage loan, and property collateral information;
b) generating automated documents relating to the foreclosure matter, the documents based on the obtained information;
c) transmitting electronically the documents generated to personnel involved with the foreclosure matter; and
d) presenting information at least comprising tracking information relating to the foreclosure matter.

65. The computer program product according to claim 64 wherein the step of presenting information comprises presenting real-time information.

66. The computer program product according to claim 65 wherein the step of presenting information comprises providing a worklist on a user computer for step-by-step real-time tracking of the foreclosure matter.

67. The computer program product according to claim 64 wherein the step of presenting information comprises presenting inquiry and/or reporting information relating to the foreclosure matter.

68. The computer program product according to claim 64 further comprising providing an electronic alert of a deadline relating to the foreclosure matter.

69. The computer program product according to claim 64 further comprising providing the foreclosure matter with a unique identification number once the foreclosure matter information is obtained.

70. An automated foreclosure method comprising:
a) providing an electronic inquiry form for the intake of information relating to a foreclosure matter;
b) implementing automated procedures and generation of documents related to appointment of a substitute trustee and filing of the appointment of the substitute trustee;
c) implementing automated procedures and generation of documents related to scheduling of a foreclosure hearing;
d) implementing automated procedures and generation of documents related to a notice of foreclosure hearing and filing of the notice of foreclosure hearing;
e) implementing automated procedures and generation of documents related to a foreclosure hearing;
f) implementing automated procedures and generation of documents related to a notice of foreclosure sale and publication of the notice of foreclosure sale;
g) implementing automated procedures and generation of documents related to a foreclosure sale;
h) implementing automated procedures and generation of documents related to finalizing results of the foreclosure sale and filing of the results of the foreclosure sale;
i) implementing automated procedures and generation of documents related to disbursement of funds obtained from the foreclosure sale; and
j) implementing automated procedures and generation of documents related to disposition of a sold property asset.
